(19) United States
(12) Patent Application Publication
(10) Pub. No.: US 2026/0273514 A1
(43) Pub. Date: Sep. 17, 2026

(54) HETEROGENEOUS CATALYST COMPOSITION AND METHODS THEREOF

(71) Applicant: Copermic Catalysts, Inc., Cambridge, MA (US)

(72) Inventors: Jacob Grose, Arlington, MA (US); Aruna Ramkrishnan, Newton, MA (US); Devin Peck, Cambridge, MA (US)

(73) Assignee: Copermic Catalysts, Inc., Cambridge, MA (US)

(21) Appl. No.: 19/471,852

(22) PCT Filed: Apr. 3, 2024
(86) PCT No.: PCT/US2024/022718

§ 371 Date: Oct. 2, 2025

Related U.S. Application Data
(60) Provisional application No. 63/457,034, filed on Apr. 4, 2023.
(60) Provisional application No. 63/467,249, filed on May 17, 2023.
(60) Provisional application No. 63/471,145, filed on Jun. 5, 2023.
(60) Provisional application No. 63/525,957, filed on Jul. 10, 2023.
(60) Provisional application No. 63/531,411, filed on Aug. 8, 2023.
(60) Provisional application No. 63/604,753, filed on Nov. 30, 2023.
(60) Provisional application No. 63/618,430, filed on Jan. 8, 2024.

(51) Int. Cl. B01J 23/89; B01J 23/10; B01J 23/745; B01J 35/45; B01J 35/61; B01J 37/02; C01C 1/04

(52) U.S. Cl. CPC B01J 23/8906; B01J 23/10; B01J 23/745; B01J 35/45; B01J 35/615; B01J 37/0201; C01C 1/0411

(57) ABSTRACT

Heterogeneous catalyst compositions that can be used for gas phase catalysis such as for ammonia synthesis and/or hydrogenation reactions are generally provided. The catalyst composition may include a catalyst (e.g., a metallic catalyst) associated with a support material (e.g., an oxide support such as a doped or undoped ceria). In some, but not all embodiments, the metal catalyst (e.g., in the form of metallic nanoparticles) is formed from one or more transition metals such as but not limited iron and/or ruthenium.

### RELATED APPLICATIONS

This application also claims priority under 35 U.S.C. § 119 (e) to U.S. Provisional Patent Application No. 63/457,034, filed Apr. 4, 2023, U.S. Provisional Patent Application No. 63/467,249, filed May 17, 2023, U.S. Provisional Patent Application No. 63/471,145, filed Jun. 5, 2023, U.S. Provisional Patent Application No. 63/525,957, filed Jul. 10, 2023, U.S. Provisional Patent Application No. 63/531,411, filed Aug. 8, 2023, U.S. Provisional Patent Application No. 63/604,753, filed Nov. 30, 2023 and U.S. Provisional Patent Application No. 63/618,430, filed Jan. 8, 2024, each of which is incorporated herein by reference in its entirety for all purposes.

### GOVERNMENT SPONSORSHIP

This invention was made with government support under ARPA-E OPEN 2021, Award #DE-AR0001556 awarded by the Department of Energy. The government may have certain rights in the invention.

### TECHNICAL FIELD

Heterogenous catalyst compositions and related systems and methods are generally described.

### BACKGROUND

The Haber-Bosch (HB) process for fixing nitrogen to ammonia was a world-changing discovery, revolutionizing our global agricultural system and winning Nobel Prizes in Chemistry for both Fritz Haber (1918) and Carl Bosch (1931). This impact continues today as millions of metric tons of ammonia are produced annually, the vast majority of which is used for fertilizer. Remarkably, little about modern ammonia production would be unfamiliar to Bosch, as the basics of the industrial HB process have not changed appreciably over the past century, despite its enormous environmental impact.

Specifically, there has been very little progress on the catalytic materials that enable the HB process, even though a catalyst with high efficiency under ambient conditions would significantly reduce the environmental impact of global ammonia production. As was the case in Bosch's time, today's iron catalysts are made by fusing potassium oxide and aluminum oxide with magnetite (Fe₃O₄) at ~1600° C. followed by hydrogen reduction, which may also contain oxides of calcium, magnesium, and/or silicon depending on reaction conditions. While ruthenium has been commercialized for ammonia catalysis, nothing to date has replaced iron as the catalyst of choice in industry, due to the combination of iron's low cost and high productivity. Accordingly, there exists a need for efficient and economically viable catalysts for producing ammonia at more mild conditions (i.e. lower temperatures and pressures).

### SUMMARY

Heterogenous catalyst compositions and related systems and methods are generally described. The subject matter of the present invention involves, in some cases, interrelated products, alternative solutions to a particular problem, and/or a plurality of different uses of one or more systems and/or articles.

In one aspect, embodiments disclosed herein relate to a heterogeneous catalyst for gas phase catalysis. The heterogeneous catalyst may include an oxide support material and a metallic material associated with a surface of the support material. For example, the heterogeneous catalyst may include an oxide support material and a metallic material on a surface of the support material. The oxide support material may comprise oxygen, 2-5 different metal elements, and optionally nitrogen and/or hydrogen. In some embodiments, the oxide support material may have a formula of AᵢDⱼEₖOₓN_{y}H_{z}, wherein A may be a first of the 2-5 different metal elements, D may be a second of the 2-5 different metal elements and is different from A, E may be a third of the 2-5 different metal elements and is different from A and D; O is oxygen, N is nitrogen, and His hydrogen, wherein i, j, and k are 0<i<1, 0<j<1, and 0<=k<1 respectively, and i+j+k=1; and wherein x, y, and z are 0.5<x<2.5, 0<=y<1, and 0<=z<1 respectively. In some embodiments, A may be a metal selected from Groups 2 or 3 of the periodic table specifically excluding lanthanoids, and D may be a metal selected from Groups 5-11 of the periodic table. In some embodiments, D may be a metallic element selected from Groups 5 or 6. The support material may have a BET surface area of at least 5 m²/g. In some embodiments, the metallic material has a formula of FeᵢRuⱼTₖ, wherein Fe is iron, Ru is ruthenium, and T is a transition metal other than Fe or Ru, and wherein 0<i<=100, 0<=j<100, 0<=k<50, and i+j+k=100. The metallic material may be an alloy or compound including between 1-99 mol % ruthenium (Ru) and 1-99 mol % iron (Fe) and optionally up to 50 mol % of other transition metals. The alloy or compound may be comprised solely of Ru and Fe.

In another aspect, embodiments disclosed herein relate to a heterogeneous catalyst for gas phase catalysis. The heterogeneous catalyst may include an oxide support material and a metallic material associated with a surface of the support material. For example, the heterogeneous catalyst may include an oxide support material and a metallic material on a surface of the support material. The oxide support material may have a formula of AᵢDⱼEₖOₓN_{y}H_{z}, wherein A may be a metallic element selected from Groups 2 or 3 of the periodic table specifically excluding lanthanoids, D may be a metallic element selected from Groups 5-11 of the periodic table and is different from A, E may be a metallic element different from A and D; O is oxygen, N is nitrogen, and H is hydrogen, wherein i, j, and k are 0<i<1, 0<j<1, and 0<=k<1 respectively, and i+j+k=1; and wherein x, y, and z are 0.5<x<2.5, 0<=y<1, and 0<=z<1 respectively. In some embodiments, D may be a metallic element selected from Groups 5 or 6. The metallic material may be a single transition metal or an alloy or compound containing 2-3 transition metals. The single transition metal may be Fe, Co, or Ru, and the alloy or compound containing 2-3 transition metals may be comprised solely of Ru and Fe.

In the aspects above, the metallic material may have a particle size ranging from 0.1 to 100 nm. The support material may have a BET surface area of at least 5 m²/g. The catalyst composition may comprise from 0.5 to 40.0% by weight of the metallic material.

In another aspect, embodiments disclosed herein relate to a method of producing ammonia. The method may include contacting a catalyst composition with a precursor gas stream comprising nitrogen and hydrogen gases and then producing ammonia at a surface of the catalyst composition. The heterogeneous catalyst may include an oxide support material and a metallic material associated with a surface of the support material. For example, the heterogeneous catalyst may include an oxide support material and a metallic material on a surface of the support material. The oxide support material may comprise oxygen, 2-5 different metal elements, and optionally nitrogen and/or hydrogen. In some embodiments, the oxide support material may have a formula of AᵢDⱼEₓOₓN_{y}H_{z}, wherein A may be a metallic element selected from Groups 2 or 3 of the periodic table specifically excluding lanthanoids, D may be a metallic element selected from Groups 5-11 of the periodic table and is different from A, E may be a metallic element different from A and D; O is oxygen, N is nitrogen, and H is hydrogen, wherein i, j, and k are 0<i<1, 0<j<1, and 0<=k<1 respectively, and i+j+k=1; and wherein x, y, and z are 0.5<x<2.5, wherein 0<=y<1, and wherein 0<=z<1 respectively. In some embodiments, the metallic material has a formula of FeᵢRuⱼTₖ, wherein Fe is iron, Ru is ruthenium, and T is a transition metal other than Fe or Ru, and wherein 0<i<=100, 0<=j<100, 0<=k<50, and i+j+k=100. The metallic material may be an alloy or compound including between 1-99 mol % Ru and 1-99 mol % Fe and optionally up to 50 mol % of other transition metals. In some embodiments, D may be a metallic element selected from Groups 5 or 6. The metallic material may be a single transition metal or an alloy or compound containing 2-3 transition metals.

In yet another aspect, embodiments disclosed herein relate to a method of producing ammonia. The method may include contacting a catalyst composition with a precursor gas stream comprising nitrogen and hydrogen gases and then producing ammonia at a surface of the catalyst composition. The heterogeneous catalyst may include an oxide support material and a metallic material associated with a surface of the support material. For example, the heterogeneous catalyst may include an oxide support material and a metallic material on a surface of the support material. The oxide support material may have a formula of AᵢDⱼEₖOₓN_{y}H_{z}, wherein A may be a metallic element selected from Groups 2 or 3 of the periodic table specifically excluding lanthanoids, D may be a metallic element selected from Groups 5-11 of the periodic table and is different from A, E may be a metallic element different from A and D; O is oxygen, N is nitrogen, and H is hydrogen, wherein i, j, and k are 0<<1, 0<j<1, and 0<=k<1 respectively, and i+j+k=1; and wherein x, y, and z are 0.5<x<2.5, 0<=y<1, and 0<=z<1 respectively. In some embodiments, D may be a metallic element selected from Groups 5 or 6. The metallic material may be a single transition metal or an alloy or compound containing 2-3 transition metals. The single transition metal may be Fe, Co, or Ru, and the alloy or compound containing 2-3 transition metals may be comprised solely of Ru and Fe.

In one aspect, embodiments disclosed herein relate to a composition that may be used as a heterogeneous catalyst for gas-phase catalysis. For example, embodiments disclosed herein may relate to a composition that may be used as a heterogeneous catalyst for gas-phase hydrogenation. The heterogeneous catalyst may include an oxide support material and a metallic material associated with a surface of the support material. For example, the heterogeneous catalyst may include an oxide support material and a metallic material on a surface of the support material. The oxide support material may comprise oxygen, 2-6 different metal elements, and optionally nitrogen and/or hydrogen. In some embodiments, the oxide support material may have a formula of AₓD_{y}Ce_{(1-x-y)}O_{z}NᵢHⱼ, wherein A is a metal element or combination of metal elements, D is either Ti (titanium) or Zr (zirconium) or a combination thereof, Ce is cerium, O is oxygen, N is nitrogen, and H is hydrogen, wherein x, y, z, i, and j are 0<x<0.5, 0<=y<=0.5, 1<z<=2, 0<=i<1, and 0<=j<1 respectively. A may include one or more of the following elements: Mg, Y, Mn, Fe, Co, Ni, Cu, Zn, Al, Ga, In, Sn, and/or Bi. The support material may have a BET surface area of at least 5 m²/g. The metallic material may be comprised of Fe, Co, Ni, Cu, Ru, and all combinations thereof.

In one aspect, a composition is provided. In some embodiments, the composition comprises an oxide support material comprising AₓD_{y}Ce_{(1-x-y)}O₂NᵢHⱼ, wherein: A is a metal element taken from the following: Mg, Y, Mn, Fe, Co, Ni, Cu, Zn, Al, Ga, In, Sn, and/or Bi; D is either Ti (titanium) or Zr (zirconium) or a combination thereof; Ce is cerium; O is oxygen; N is nitrogen; and H is hydrogen; wherein x, y, z, i, and j are 0<x<0.5, 0<=y<=0.5, 1<z<=2, 0<=i<1, and 0<=j<1 respectively; and a metallic material associated with a surface of the oxide support material, the metallic material comprising at least 50 mol % Fe (iron).

In another aspect, embodiments disclosed herein relate to a method of producing ammonia. The method may include contacting a catalyst composition with a precursor gas stream comprising nitrogen and hydrogen gases and then producing ammonia at a surface of the catalyst composition. The heterogeneous catalyst may include an oxide support material and a metallic material associated with a surface of the support material. For example, the heterogeneous catalyst may include an oxide support material and a metallic material on a surface of the support material. In some embodiments, the oxide support material may have a formula of AₓD_{y}Ce_{(1-x-y)}ONᵢHⱼ, wherein A is a metal element or combination of metal elements, D is either Ti (titanium) or Zr (zirconium) or a combination thereof, Ce is cerium, O is oxygen, N is nitrogen, and H is hydrogen, wherein x, y, z, i, and j are 0<x<0.5, 0<=y<=0.5, 1<<=2, 0<=i<1, and 0<=j<1 respectively. A may include one or more of the following elements: Mg, Y, Mn, Fe, Co, Ni, Cu, Zn, Al, Ga, In, Sn, and/or Bi. The metallic material may be comprised of Fe, Co, Ni, Cu, Ru, and all combinations thereof.

The method includes contacting a catalyst composition with ammonia gas and producing nitrogen and hydrogen gases at a surface of the catalyst composition. The heterogeneous catalyst may include an oxide support material and a metallic material associated with a surface of the support material. For example, the heterogeneous catalyst may include an oxide support material and a metallic material on a surface of the support material. In some embodiments, the oxide support material may have a formula of AₓD_{y}Ce_{(1-x-y)}O₂NᵢHⱼ, wherein A is a metal element or combination of metal elements, D is either Ti (titanium) or Zr (zirconium) or a combination thereof, Ce is cerium, O is oxygen, N is nitrogen, and H is hydrogen, wherein x, y, z, i, and j are 0<x<0.5, 0<=y<=0.5, 1<<<=2, 0<=i<1, and 0<=j<1 respectively. A may include one or more of the following elements: Mg, Y, Mn, Fe, Co, Ni, Cu, Zn, Al, Ga, In, Sn, and/or Bi. The metallic material may be comprised of Fe, Co, Ni, Cu, Ru, and all combinations thereof.

In one aspect, embodiments disclosed herein relate to a supported heterogeneous catalyst composition for gas-phase catalysis. The supported catalyst may include an oxide support material and a metallic material associated with a surface of the support material. For example, the supported catalyst composition may include a metallic material on a surface of a catalyst support material, wherein the metallic material has a formula of FeᵢRuⱼTₖ, wherein Fe is iron, Ru is ruthenium, and T is a transition metal other than Fe or Ru, and wherein 0<<=100, 0<=j<100, 0<=k<50, and i+j+k=100. In some embodiments, the supported catalyst composition may include a metallic material on a surface of a catalyst support material, wherein the metallic material has a formula of FeᵢRuⱼTₖ, wherein Fe is iron, Ru is ruthenium, and T is a transition metal other than Fe or Ru, and wherein 1<i<99, 1<j<99, 0<=k<50, and i+j+k=100. In other embodiments, ranges may include, but are not limited to, 0.1<=i/(i+j)<=0.9, 0.2<=i/(i+j)<=0.8, 0.3<=i/(i+j)<=0.7, and 0.4<=i/(i+j)<=0.6. In some embodiments, the supported catalyst composition enables single-pass yields of ammonia synthesized from hydrogen gas and nitrogen gas precursors at a 3:1 H₂:N₂ ratio in excess of 3% at 350° C., 75 bar total pressure, and 10000 h⁻¹ gas hourly space velocity (GHSV). The supported catalyst composition may enable single-pass yields of ammonia synthesized from hydrogen gas and nitrogen gas precursors at a 3:1 H₂:N₂ ratio in excess of 5% at 350° C., 75 bar total pressure, and 5000 h⁻¹ gas hourly space velocity (GHSV). In some embodiments, these catalysts are reduced in a hydrogen or hydrogen-containing atmosphere at temperatures between 200-1200° C. and total pressures between 1-100 bar for times between 3-48 hours. Other conditions may include, but are not limited to, temperatures between 200-400° C. and total pressures between 1-10 bar for times between 3-48 hours; temperatures between 200-400° C. and total pressures between 10-50 bar for times between 3-48 hours; temperatures between 200-400° C. and total pressures between 50-100 bar for times between 3-48 hours; temperatures between 400-600° C. and total pressures between 1-50 bar for times between 3-48 hours; temperatures between 400-600° C. and total pressures between 50-100 bar for times between 3-48 hours; and temperatures between 600-1200° C. and total pressures between 1-100 bar for times between 3-48 hours.

The supported catalyst composition may comprise from 0.1 to 40.0% by weight of the metallic material. The metallic material may be comprised solely of Ru and Fe. The metallic material may have a particle size ranging from 0.1 to 100 nm. The catalyst support material may be selected from the following materials: ceria (CeO₂), graphite, ceramics with the perovskite crystal structure, and/or combinations of the same. The catalyst support material may have a BET surface area of at least 5 m²/g. The supported heterogeneous catalyst composition may have an agglomerated particle size ranging from 25 μm to 10 mm as measured via mechanical sieving.

The supported heterogeneous catalyst composition also may include an additional component selected from the group consisting of an electronic promoter, a structural promoter, and combinations thereof. The electronic promoter may be selected from the group consisting of Li, Na, K, Rb, Cs, Mg, Ca, Sr, Ba, Ce, oxides thereof, salts thereof, and combinations thereof. The structural promoter may be selected from the group consisting of Al₂O₃, CaCO₃, graphene oxide nanosheets, activated carbons, meso-porous carbons, meso-porous silicas, melon foams and combinations thereof. The supported catalyst composition may include a binder selected from the group consisting of carbon black, glucose, hydroxyethyl cellulose, formaldehyde, alumina, silica, alite (3CaO·SiO₂), belite (2CaO·SiO₂), tricalcium aluminate or celite (3CaO·Al₂O₃), brownmillerite (4CaO·Al₂O₃·Fe₂O₃), and combinations thereof.

In another aspect, embodiments disclosed herein relate to a process for production of ammonia from hydrogen and nitrogen gases that may use the supported catalyst composition. Ammonia production volume may be less than 10,000 tons/day, less than 1000 tons/day, or less than 100 tons/day.

In another aspect, embodiments disclosed herein relate to a method of producing ammonia. The method may include contacting a supported catalyst composition with a precursor gas stream comprising nitrogen and hydrogen gases and producing ammonia at a surface of the supported catalyst composition. The supported catalyst may include an oxide support material and a metallic material associated with a surface of the support material. For example, the supported catalyst composition may comprise a metallic material on a surface of a catalyst support material, wherein the metallic material has a formula of FeᵢRuⱼTₖ, wherein Fe is iron, Ru is ruthenium, and T is a transition metal other than Fe or Ru, and wherein 0<i<=100, 0<=j<100, 0<=k<50, and i+j+k=100. In some embodiments, the supported catalyst composition may comprise a metallic material on a surface of a catalyst support material, wherein the metallic material has a formula of FeᵢRuⱼTₖ, wherein Fe is iron, Ru is ruthenium, and T is a transition metal other than Fe or Ru, and wherein 1<i<99, 1<j<99, 0<=k<50, and i+j+k=100. In some embodiments, the supported catalyst composition enables single-pass yields of ammonia synthesized from hydrogen gas and nitrogen gas precursors at a 3:1 H₂:N₂ ratio in excess of 3% at 350° C., 75 bar total pressure, and 10000 h⁻¹ gas hourly space velocity (GHSV). The supported catalyst composition may enable single-pass yields of ammonia synthesized from hydrogen gas and nitrogen gas precursors at a 3:1 H₂:N₂ ratio in excess of 5% at 350° C., 75 bar total pressure, and 5000 h⁻¹ GHSV. The support material may include vacancies, dopants, impurities, and combinations thereof in an amount of not greater than 15 atomic %. The support material may have a BET surface area of at least 5 m²/g. The supported catalyst composition may comprise from 0.1 to 40% by weight of the metallic material. In other embodiments, the supported catalyst composition may comprise between 0.1-1%, between 0.1-5%, between 0.1-10%, between 0.1-20%, or between 0.1-40% by weight of the metallic material.

The contacting and/or producing steps may be conducted at a temperature ranging from 0° C. to 500° C. For example, the contacting and/or producing steps may be conducted at a temperature ranging from 0° C. to 450° C. The contacting and/or producing steps may be conducted at a pressure ranging from 1 bar to 200 bar. The contacting and/or producing steps may be conducted in the absence of an applied electric field applied to the supported catalyst composition or may be conducted with either a DC or AC electric field, or electromagnetic radiation, including but not limited to either microwaves or visible light, applied to the supported catalyst composition. It should be appreciated that an absence of an applied electric field may include a negligible but measurable electric field such as 1V in embodiments of the present disclosure. The producing step may produce ammonia at a rate of at least 1 mmol product/gram catalyst/hour for a single pass over a single bed under standard commercial reactor space velocities. The contacting and/or producing steps may be conducted in a reactor selected from the group consisting of a batch reactor, a semibatch reactor, a continuous stirred tank reactor, a plug-flow reactor, a trickle-bed reactor, a fixed bed reactor, a moving bed reactor, a rotating bed reactor, a slurry reactor, a tubular reactor, a radial and axial packed bed reactor, a membrane reactor, and a fluidized bed reactor. The method also may include separating ammonia from the precursor gas stream via a technique selected from the group consisting of condensation, pressure swing adsorption, temperature swing adsorption, microwave swing adsorption, vacuum swing adsorption, and combinations thereof.

Other advantages and novel features of the present invention will become apparent from the following detailed description of various non-limiting embodiments of the invention when considered in conjunction with the accompanying figures. In cases where the present specification and a document incorporated by reference include conflicting and/or inconsistent disclosure, the present specification shall control.

### BRIEF DESCRIPTION OF THE DRAWINGS

Non-limiting embodiments of the present invention will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the invention shown where illustration is not necessary to allow those of ordinary skill in the art to understand the invention. In the figures:

FIG. 1 depicts a cross-sectional schematic illustration of a catalyst composition comprising a metallic material associated with a support material according to an embodiment of the present disclosure;

FIG. 2 depicts a cross-sectional schematic diagram of a reactor comprising an inlet and a reactor vessel containing a catalyst composition, according to an embodiment of the present disclosure;

FIG. 3 depicts an example of a gray ammonia process according to an embodiment of the present disclosure;

FIG. 4 depicts an example of a zero-carbon green ammonia process according to an embodiment of the present disclosure;

FIGS. 5A-5C show plots of ammonia yield versus temperature at 15000 h⁻¹ GHSV (FIG. 5A), ammonia yield versus temperature at 10000 h⁻¹ GHSV (FIG. 5B), and a ratio of the productivity of RuFe on Ce_{0.5}Zr_{0.3}Y_{0.2}O₍₂₋ₓ₎ catalyst divided by the productivity of a commercial iron catalyst at various temperatures (FIG. 5C), according to an embodiment of the present disclosure; and

FIGS. 6A-6C show plots of ammonia productivity versus temperature for an Fe on 10% Fe-doped CeO₂ catalyst composition and a commercial iron (FIG. 6A), ammonia yield versus temperature (FIG. 6B), and a ratio of the productivity of the Fe on 10% Fe-doped CeO₂ catalyst composition divided by the productivity of the commercial iron catalyst at various temperatures and conditions (FIG. 6C), according to an embodiment of the present disclosure.

### DETAILED DESCRIPTION

Heterogeneous catalyst compositions that can be used for gas phase catalysis such as for ammonia synthesis and/or hydrogenation reactions are generally provided. The catalyst composition may include a catalyst (e.g., a metallic catalyst) associated with a support material (e.g., an oxide support such as a doped or undoped ceria). In some, but not all embodiments, the metal catalyst (e.g., in the form of metallic nanoparticles) is formed from one or more transition metals such as but not limited iron and/or ruthenium. The catalyst composition may include a support comprising, for example, an oxide material such as ceria. In some instances, the ceria is doped. Surprisingly, it has been found that certain combinations of supports (e.g., doped ceria) and metallic catalysts (e.g., comprising Fe, Ru, and/or a combination thereof) can afford significant yields and/or productivities for gas phase catalysis reactions (e.g., ammonia synthesis) even under relatively mild conditions.

While ammonia synthesis catalysts containing either Fe or Ru have been commercialized successfully, it is believed that catalysts containing alloys or compounds combining Fe and Ru—with and without additional transition metals—have not been commercialized to date. This may be in part because, prior to this disclosure, the performance of supported heterogeneous catalysts containing alloys or compounds comprised of Fe and Ru and optionally other transition metals for ammonia synthesis at low temperatures (<400° C.) and pressures (e.g., <100 bar) has not been shown to be significantly better than that of Ru alone. Some aspects of the present disclosure involve supported heterogeneous catalysts containing alloys comprised of Fe and Ru and optionally other transition metals that have significantly improved performance for ammonia synthesis at low temperatures (e.g., <400° C.) and pressures (e.g., <100 bar). In some instances, this improvement is due at least in part to the combination of the catalyst material composition along with the specific techniques used to synthesize these catalysts. These results are consistent with proprietary computer models that have predicted that RuFe-based catalysts should significantly outperform similar Ru-based catalysts for ammonia synthesis under these milder reactor conditions. In some embodiments, the specific synthetic techniques relate to gas-phase reduction processes. Without wishing to be bound by any theory, it may be that these synthesis techniques may lead to changes (e.g., physical changes) in the catalyst that are measurable by various analytical techniques.

### Heterogeneous Gas Phase Catalyst Composition

In one aspect, embodiments disclosed herein relate to a heterogeneous catalyst composition that may be used for gas phase catalysis. For example, in one aspect, embodiments disclosed herein relate to a heterogeneous catalyst composition that may be used for gas-phase hydrogenation. The catalyst composition may be a supported catalyst composition. In some embodiments, the supported catalyst composition includes a metallic material associated with a support material. As one non-limiting example, the supported catalyst composition may include a metallic material on a surface of a catalyst support material. For example, the heterogeneous catalyst may include an oxide support material and a metallic material on the support material.

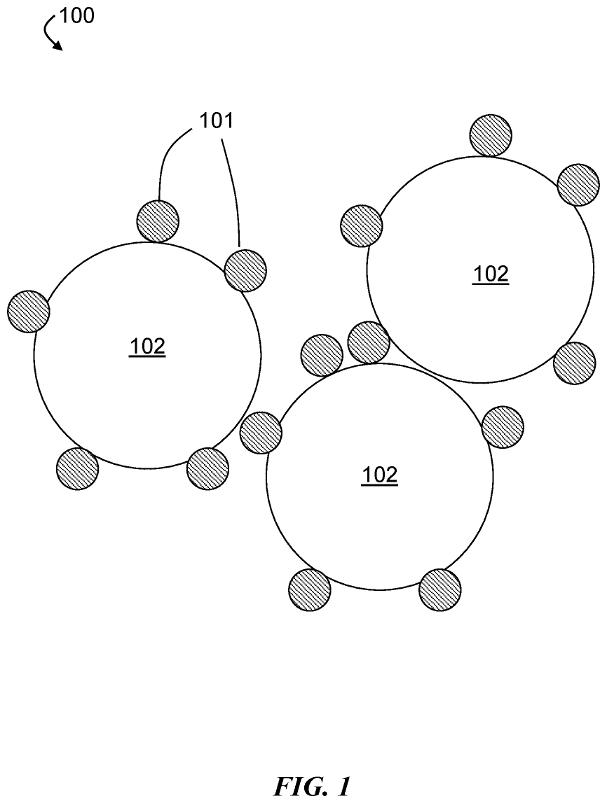

FIG. 1 shows a schematic cross-sectional illustration of heterogeneous catalyst composition 100, according to some embodiments. As noted above, the metallic material may be associated with the support material. Such as association may occur in any of a variety of ways involving direct or indirect contact between the metallic material and the support material. As one example, the metallic material may be affixed (directly or indirectly) to the support material. In some, but not necessarily all embodiments, the metallic material is on the support material. Referring, again to FIG. 1, composition 100 comprises metallic material 101 on support material 102. In some embodiments, the metallic material is in the form of particles (e.g., nanoparticles) dispersed on the support material. In some embodiments, some particles of the metallic material are also within a portion of the support material (e.g., within pores, cracks, and/or channels within the support material). While support material 102 is shown as being in the form of spherical particles in FIG. 1, other forms of the support material are possible (e.g., other shapes or extended solid materials such as substrates and/or wires).

It should be understood that when a portion (e.g., metallic material catalyst particle) is “on”, “adjacent”, “in contact with”, or “supported by” another portion (e.g., support material), it can be directly on the portion, or an intervening portion (e.g., layer, coating) also may be present. A portion that is “directly on”, “directly adjacent”, “in direct contact with”, or “directly supported by” another portion means that no intervening portion is present. It should also be understood that when a portion is referred to as being “on”, “adjacent”, “in contact with”, or “supported by” another portion, it may cover the entire portion or a part of the portion (e.g., at least 1%, at least 2%, at least 5%, at least 10%, at least 25%, and/or up to 50%, up to 75%, up to 90%, or more by area).

As used herein, a “support material” refers to a material to which a catalyst is affixed. A catalyst support material may be a solid with a high surface area to which a metallic material may be affixed in gas phase catalysis. For example, a catalyst support material may be a solid with a high surface area to which a metallic material may be affixed in ammonia production. In one or more embodiments, the metallic material may be chemically bonded or adsorbed to the support material without ligands or other coordinating compounds in between the metallic material and the support material.

A composition that may be used as a heterogeneous catalyst may include an oxide support material and a metallic material associated with a surface of the support material. For example, the composition that may be used as a heterogeneous catalyst may include an oxide support material and a metallic material on a surface of the support material. The oxide support material may comprise oxygen, 2-5 different metal elements, and optionally nitrogen and/or hydrogen. In some embodiments, the oxide support material may have a formula of AₓD_{y}Ce_{(1-x-y)}O₂NᵢHⱼ, wherein A may be a first of the 2-5 different metal elements, D may be a second of the 2-5 different metal elements and is different from A, E may be a third of the 2-5 different metal elements and is different from A and D; O is oxygen, N is nitrogen, and H is hydrogen, wherein i, j, and k are 0<i<1, 0<j<1, and 0<=k<1 respectively, and i+j+k=1; and wherein x, y, and z are 0.5<x<2.5, 0<=y<1, and 0<=z<1 respectively. In some embodiments, A may be a metal selected from Groups 2 or 3 of the periodic table specifically excluding lanthanoids, and D may be a metal selected from Groups 5-11 of the periodic table. In some embodiments, D may be a metal selected from Groups 5 or 6. Non-limiting examples of support materials include CaVO_{3-δ}, CaVO_{3-δ}H_{δ}, SrVO_{3-δ}, SrVO_{3-δ}H_{δ}, SrVₓAl₁₋ₓO_{3-δ}, BaVO_{3-δ}, BaVO_{3-δ}H_{δ}, BaVₓAl₁₋ₓO_{3-δ}, Sr₃V₂O₇, BaV₂O₇, Sr₂VO₄, Ba₂ VO₄, CaMnO_{3-δ}, CaMnO_{3-δ}H_{δ}, SrMnO_{3-δ}, SrMnₓAl₁₋ₓO_{3-δ}, BaMnO_{3-δ}, BaMnₓAl₁₋ₓO_{3-δ}, Sr₃Mn₂O₇, BaMn₂O₇, Sr₂MnO₄, Ba₂MnO₄, SrFeO_{3-δ}, SrFeₓAl₁₋ₓO_{3-δ}, BaFeO_{3-δ}, BaFeₓAl₁₋ₓO_{3-δ}, Sr₃Fe₂O₇, BaFe₂O₇, Sr₂FeO₄, Ba₂FeO₄, SrCoO_{3-δ}, SrCoₓAl₁₋ₓO_{3-δ}, BaCoO_{3-δ}, BaCoxAl₁₋ₓO_{3-δ}, Sr₃Co₂O₇, BaCo₂O₇, Sr₂CoO₄, Ba₂CoO₄, SrNiO_{3-δ}, SrNiₓAl₁₋ₓO_{3-δ}, BaNiO₃-δ, BaNiₓAl₁₋ₓO_{3-δ}, Sr₃Ni₂O₇, BaNi₂O₇, Sr₂NiO₄, and Ba₂NiO₄, whereby 0<=δ<1 and 0.1<=x<=1. In some embodiments, the support material comprises doped ceria. The ceria may be doped with one or more metal elements, as described in more detail below. The support material may have a BET surface area of at least 5 m²/g. In some embodiments, the metallic material has a formula of FeᵢRuⱼTₖ, wherein Fe is iron, Ru is ruthenium, and T is a transition metal other than Fe or Ru, and wherein 0<i<=100, 0<=j<100, 0<=k<50, and i+j+k=100. The metallic material may be an alloy or compound including between 1-99 mol % ruthenium (Ru) and 1-99 mol % iron (Fe) and optionally up to 50 mol % of other transition metals. The alloy or compound may be comprised solely of Ru and Fe. In other embodiments, the oxide support material may have a formula of AᵢDⱼEₖOₓN_{y}H_{z}, wherein A may be a metallic element selected from Groups 2 or 3 of the periodic table specifically excluding lanthanoids, D may be a metallic element selected from Groups 5-11 of the periodic table and is different from A, E may be a metallic element different from A and D; O is oxygen, N is nitrogen, and His hydrogen, wherein i, j, and k are 0<i<1, 0<j<1, and 0<=k<1 respectively, and i+j+k=1; and wherein x, y, and z are 0.5<x<2.5, 0<=y<1, and 0<=z<1 respectively. The metallic material may be a single transition metal or an alloy or compound containing 2-3 transition metals. The single transition metal may be Fe, Co, or Ru, and the alloy or compound containing 2-3 transition metals may be comprised solely of R^{u} and Fe. Non-limiting examples of support materials include CaVO_{3-δ}, CaVO_{3-δ}H_{δ}, SrVO_{3-δ}, SrVO_{3-δ}H_{δ}, SrVₓAl₁₋ₓO_{3-δ}, BaVO_{3-δ}, BaVO_{3-δ}H_{δ}, BaVₓAl₁₋ₓO_{3-δ}, Sr₃V₂O₇, BaV₂O₇, Sr₂VO₄, Ba₂VO₄, CaMnO_{3-δ}, CaMnO_{3-δ}H_{δ}, SrMnO_{3-δ}, SrMnxAl₁₋ₓO_{3-δ}, BaMnO_{3-δ}, BaMnₓAl₁₋ₓO_{3-δ}, Sr₃Mn₂O₇, BaMn₂O₇, Sr₂MnO₄, Ba₂MnO₄, SrFeO₃-δ, SrFeₓAl₁₋ₓO_{3-δ}, BaFeO₃-δ, BaFeₓAl₁₋ₓO_{3-δ}, Sr₃Fe₂O₇, BaFe₂O₇, Sr₂FeO₄, Ba₂FeO₄, SrCo₀₃-δ, SrCoₓAl₁₋ₓO_{3-δ}, BaCoO_{3-δ}, BaCoₓAl₁₋ₓO_{3-δ}, Sr₃Co₂O₇, BaCo₂O₇, Sr₂CoO₄, Ba₂CoO₄, SrNiO_{3-δ}, SrNixAl₁₋ₓO_{3-δ}, BaNiO_{3-δ}, BaNiₓAl₁₋ₓO_{3-δ}, Sr₃Ni₂O₇, BaNi₂O₇, Sr₂NiO₄, and Ba₂NiO₄, whereby 0<=8<1 and 0.1<=x<=1.

As noted above, the composition that may be used as a heterogeneous catalyst may include an oxide support material and a metallic material associated with a surface of the support material. For example, the heterogeneous catalyst may include an oxide support material and a metallic material on a surface of the support material. The oxide support material may comprise oxygen, 2-6 different metal elements, and optionally nitrogen and/or hydrogen. In some embodiments, the oxide support material may have a formula of AₓD_{y}Ce_{(1-x-y)}O₂NᵢHⱼ, wherein A is a metal element or combination of metal elements, D is either Ti (titanium) or Zr (zirconium) or a combination thereof, Ce is cerium, O is oxygen, N is nitrogen, and H is hydrogen, wherein x, y, z, i, and j are 0<x<0.5, 0<=y<=0.5, 1<<<=2, 0<=i<1, and 0<=j<1 respectively. In some embodiments, A is present in a relatively large amount (e.g., to provide a level of doping sufficient to enhance catalysis performance). For example, in some embodiments, 0.05<x<0.5, 0.1<x<0.5, or 0.2<x<0.5. A may include one or more of the following elements: Mg, Y, Mn, Fe, Co, Ni, Cu, Zn, Al, Ga, In, Sn, and/or Bi. In some embodiments, A is or comprises iron (Fe). The Fe may be present in the support as a dopant for replacing Ce atoms in an amount of greater than or equal to 5%, greater than or equal to 10%, and/or up to 30%, up to 35%, up to 40%, or up to 50% by weight of the support. The support material may have a BET surface area of at least 5 m²/g. The metallic material may be comprised of Fe, Co, Ni, Cu, Ru, or a combination thereof. In some embodiments, the catalyst composition has an overall chemical formula of Ce_{0.74}Fe_{0.26}O₍₂₋ₓ₎, where x represents the level of oxygen vacancy (which may be zero or nonzero).

As noted above, the supported catalyst composition may include a metallic material associated with the catalyst support material. For example, the supported catalyst composition may include a metallic material on a surface of a catalyst support material. In some embodiments, the metallic material has a formula of FeᵢRuⱼTₖ, wherein Fe is iron, Ru is ruthenium, and T is a transition metal other than Fe or Ru, and wherein 0<i<=100, 0<=j<100, 0<=k<50, and i+j+k=100. In some embodiments, the metallic material has a formula of FeᵢRuⱼTₖ, wherein Fe is iron, Ru is ruthenium, and T is a transition metal other than Fe or Ru, and wherein 1<i<99, 1<j<99, 0<=k<50, and i+j+k=100. In some embodiments, the metallic material may be comprised solely of Ru and Fe, comprised of Ru:Fe molar ratios including, but not limited to, from 4.5:5.5 and 5.5:4.5, from 4:6 and 6:4, from 3:7 and 7:3, from 2:8 and 8:2, and from 1:9 and 9:1. In some embodiments, the molar ratio of Ru to Fe may be 1:1. In some embodiments, the catalyst support material may be selected from the following materials: ceria (CeO₂), graphite, ceramics with the perovskite crystal structure, or combinations thereof.

In some embodiments, Ru is present in the metallic material in an amount of greater than or equal to 1 mol %, greater than or equal to 10 mol %, greater than or equal to 20 mol %, greater than or equal to 30 mol %, greater than or equal to 40 mol %, greater than or equal to 45 mol %, greater than or equal to 50 mol %, greater than or equal to 55 mol %, and/or up to 60 mol %, up to 70 mol %, up to 90 mol %, up to 99 mol %, or higher (e.g., 100 mol %). In some such embodiments where Ru is not the sole metal in the metallic material, at least 50 mol %, at least 75 mol %, at least 90 mol %, at least 95 mol %, at least 99 mol %, or all of the balance of the metallic material is Fe.

In some embodiments, Fe is present in the metallic material in an amount of greater than or equal to 1 mol %, greater than or equal to 10 mol %, greater than or equal to 20 mol %, greater than or equal to 30 mol %, greater than or equal to 40 mol %, greater than or equal to 45 mol %, greater than or equal to 50 mol %, greater than or equal to 55 mol %, and/or up to 60 mol %, up to 70 mol %, up to 90 mol %, up to 99 mol %, or higher (e.g., 100 mol %). In some such embodiments where Fe is not the sole metal in the metallic material, at least 50 mol %, at least 75 mol %, at least 90 mol %, at least 95 mol %, at least 99 mol %, or all of the balance of the metallic material is Ru.

Some aspects of the present disclosure may involve supported heterogeneous catalysts containing alloys comprising Fe and Ru and optionally other transition metals. The catalysts may have significantly improved performance for ammonia synthesis at low temperatures (<500° C. or <450° C.) and pressures (<100 bar) due to the combination of the catalyst material composition along with the specific techniques used to synthesize these catalysts. In some embodiments, these techniques relate to calcination processes, wherein supported heterogeneous catalysts are reduced in a hydrogen or hydrogen-containing atmosphere at temperatures between 200-1200° C. and total pressures between 1-100 bar for times between 6-48 hours (see Table 1 below). Without wishing to be bound by any theory, it may be that these synthesis techniques may lead to changes (e.g., physical changes) in the catalyst that are measurable by techniques such as X-ray diffraction (XRD), X-ray absorption spectroscopy (XAS), X-ray absorption near edge structure (XANES or NEXAFS), or Energy-dispersive X-ray spectroscopy (EDX or EDS) used in conjunction with electron microscopy (SEM, STEM, or TEM).

The supported catalyst composition may enable single-pass yields of ammonia synthesized from hydrogen gas and nitrogen gas precursors at a 3:1 H₂:N₂ ratio in excess of 3% at 350° C., 75 bar total pressure, and 10000 h⁻¹ GHSV. In some embodiments, yields may be in excess of 5%, in excess of 8%, in excess of 10%, or in excess of 15%. In some embodiments, the yields may be up to 20%, up to 25%, or greater. Combinations of these ranges are possible.

The supported catalyst composition may enable single-pass yields of ammonia synthesized from hydrogen gas and nitrogen gas precursors at a 3:1 H₂:N₂ ratio in excess of 5% at 350° C., 75 bar total pressure, and 5000 h⁻¹ GHSV. In some embodiments, yields may be in excess of 8%, in excess of 10%, or in excess of 15%. In some embodiments, the yields may be up to 20%, up to 25%, up to 30%, or greater. Combinations of these ranges are possible. While certain process conditions are set forth herein, it should be appreciated that the commercial reactor conditions may range from 200-500° C., 1-200 bar total pressure, and 1000-50000 h⁻¹ GHSV in embodiments of the present disclosure. Other conditions are possible.

The support materials described herein may include a sufficiently high surface area such that sufficient catalyst can be affixed to the support and available for catalysis. For example, the support material may have a BET surface area of at least 5 m²/g, and ranging from 5 m²/g to 3000 m²/g. The support material may have a BET surface area having a lower limit of any one of 5 m²/g, 50 m²/g, 100 m²/g, 150 m²/g, 200 m²/g, 300 m²/g, 500 m²/g, 750 m²/g and 1000 m²/g and/or an upper limit of any one of 1200 m²/g, 1500, m²/g, 1750 m²/g, 2000 m²/g, 2500 m²/g and 3000 m²/g, where any lower limit may be paired with any mathematically compatible upper limit.

As noted above, the compositions that may be used as a heterogeneous catalyst described herein may include a metallic material. The metallic material may be chemically bonded or adsorbed to the support material thereby forming the heterogeneous catalyst composition. The metallic material may have a particle size sufficient to achieve good catalytic performance without degrading the support material. In one or more embodiments, the particle size of the metallic material may range from 0.1 nm to 100 nm (nanometers) as measured via transmission electron microscopy (TEM). This particle size may refer to an average (median) particles size as measured via TEM. For example, the particle size may have a lower limit of any one of 0.1, 0.2, 0.5, 1.0, 2.0, 5.0, 10, 15, 20, 25 and 30 nm and an upper limit of any one of 40, 50, 60, 70, 80, 90 and 100 nm, where any lower limit may be paired with any mathematically compatible upper limit.

As used herein, a transition metal element can be scandium (Sc), titanium (Ti), vanadium (V), chromium (Cr), manganese (Mn), iron (Fe), cobalt (Co), nickel (Ni), copper (Cu), zinc (Zn), yttrium (Y), zirconium (Zr), niobium (Nb), molybdenum (Mo), technetium (Tc), ruthenium (Ru), rhodium (Rh), palladium (Pd), silver (Ag), cadmium (Cd), hafnium (Hf), tantalum (Ta), tungsten (W), rhenium (Re), osmium (Os), iridium (Ir), platinum (Pt), gold (Au), or mercury (Hg).

The amount of metallic material in the catalyst composition may be sufficient to achieve a suitable rate of catalysis, but low enough that good catalytic performance may be maintained while providing an economically feasible catalyst. In one or more embodiments, the catalyst composition comprises from 0.1 to 40.0% by weight of the metallic material. In one or more embodiments, the catalyst composition comprises from 0.5 to 40.0% by weight of the metallic material. In one or more embodiments, the catalyst composition comprises from 0.1 to 20.0% by weight of the metallic material. For example, the metallic material may be included in the catalyst composition in an amount having a lower limit of any one of 0.1, 0.5, 1.0, 1.5, 2.0, 2.5, 5.0, 7.5, 10.0, 15.0 and 20.0 wt % (weight percent) and an upper limit of any one of 7.5, 10.0, 15.0, 20.0, 30.0, and 40.0 wt %, where any lower limit may be paired with any mathematically compatible upper limit. For example, the metallic material may be include in the catalyst composition in an amount of greater than or equal to 2 wt % and less than or equal to 10%, greater than or equal to 2 wt % and less than or equal to 5%, or greater than or equal to 5 wt % and less than or equal to 10%,

The catalytic activity of the catalyst may be adjusted by pairing an oxide support material with a specific metallic material. Specific metallic materials may achieve better performance on particular oxide supports. As such, the catalytic activity of the heterogeneous catalyst material may be tuned and/or adjusted by such pairings.

In addition to the support material and the metallic material as described above, the heterogeneous catalysis composition described here may include additional components. For example, structural promoters to enhance the mechanical properties and electronic promoters to enhance the electronic properties may be included. As such, the catalyst composition may include an additional component selected from the group consisting of an electronic promoter, a structural promoter, and combinations thereof. In such embodiments, the electronic promoter may be selected from the group consisting of Li, Na, K, Rb, Cs, Mg, Ca, Sr, Ba, Ce, oxides thereof, salts thereof, and combinations thereof. The electronic promoter may be present in the composition in an amount of greater than or equal to 0.1 wt % greater than or equal to 0.2 wt %, greater than or equal to 0.5 wt %, greater than or equal to 1 wt %, greater than or equal to 2 wt %, greater than or equal to 5 wt %, and/or up to 10 wt %, up to 15 wt %, up to 20 wt %, or more by mass of the composition. The structural promoter may be selected from the group consisting of Al₂O₃, CaCO₃, graphene oxide nanosheets, activated carbons, meso-porous carbons, meso-porous silicas, melon foams and combinations thereof. In some embodiments, the structural promoter is selected from the group consisting of MgO, Al₂O₃, CaCO₃, zeolites, graphene oxide nanosheets, activated carbons, meso-porous carbons, meso-porous silicas, melon foams and combinations thereof. The structural promoter may be present in the composition in an amount of greater than or equal to 0.1 wt % greater than or equal to 0.2 wt %, greater than or equal to 0.5 wt %, greater than or equal to 1 wt %, greater than or equal to 2 wt %, greater than or equal to 5 wt %, and/or up to 10 wt %, up to 15 wt %, up to 20 wt %, or more by mass of the composition.

As used herein, “activated carbon” refers to a carbon material that has been chemically or physically activated to have small, low-volume pores (smaller than 2 nm in diameter and generally referred to as “micropores”) resulting in a high surface area of from about 500 to 3,000 m²/g. As used herein, “meso-porous carbon” refers to a carbon material having pores ranging in diameter from about 2 to 50 nm. As used herein, a “meso-porous silica” refers to a silica material having pores ranging in diameter from about 2 to 50 nm. As used herein, a “melon foam” refers to a polymeric foam derived from melon or melon polymer supported on a separate polymeric foam.

As will be explained below, the heterogeneous catalyst composition may be synthesized as a powder and then further processed to agglomerate the powder into larger granules or agglomerates using techniques such as granulation, extrusion, tableting/pelletizing, and milling. In such embodiments, the catalyst composition may further comprise a binder for binding the powder into agglomerates. The binder may be selected from the group consisting of carbon black, glucose, hydroxyethyl cellulose, formaldehyde, alumina, silica, alite (3CaO·SiO₂), belite (2CaO·SiO₂), tricalcium aluminate or celite (3CaO·Al₂O₃), brownmillerite (4CaO·Al₂O₃·Fe₂O₃), and combinations thereof. The support may also be formed into tablets without the inclusion of a binder.

In embodiments in which the catalyst composition is in the form of granules or agglomerates, the catalyst composition may have an agglomerated particle size ranging from 25 μm to 10 mm as measured via mechanical sieving. For example, the agglomerated particle size may have a lower limit of any one of 25 μm, 50 μm, 100 μm, 500 μm, 750 μm, and 1.0 mm, and/or an upper limit of any one of 750 μm, 1.0 mm, 2.0 mm. 5.0 mm, and 10 mm, where any lower limit may be paired with any mathematically compatible upper limit. The shapes of the agglomerated particles may be rings, spheres, tablets, cylinders, trilobes, quadralobes, pellets and irregularly shaped particles, among others.

### Method of Making a Heterogeneous Catalyst Composition

In another aspect, embodiments disclosed herein relate to a method of making the previously described heterogeneous catalyst. The method may include first making a catalyst support, forming metallic particles (e.g., nanoparticles), and associating the metallic particles with the support via any of a variety of techniques, including but not limited to wet impregnation, colloidal deposition, or deposition-precipitation. For example, the method may include first making a catalyst support and then forming metallic nanoparticles on this support via any of a variety of techniques, including but not limited to wet impregnation, colloidal deposition, or deposition-precipitation. For example, the method may include first making an oxide support and then impregnating the support with the metallic material via a wet impregnation technique. The oxide support, for example, may be synthesized by calcining a mixture of the metal precursors along with a combustible organic dispersant and surfactant in a stepwise manner at progressively increasing temperatures in the range of 50-1500° C. As another example, the oxide support, may be synthesized by coprecipitation in aqueous solvents or by thermal processing in a pulsation reactor between 250-1000° C.

A non-limiting example of a suitable wet impregnation synthesis includes mixing the support (e.g., comprising ceria (CeO₂), graphite, and/or ceramics with the perovskite crystal structure) with an aqueous solution including a soluble salt of two or more of the aforementioned metals. An example of such a suitable wet impregnation synthesis includes mixing the oxide powder with an aqueous solution including a soluble salt of one of the aforementioned metals. These salts may be nitrates, acetates, sulfates, halides, or oxides, for example. The metal salt may be included in an amount such that a ratio of the mass of the metal to the mass of the oxide support is from about 1.0 to 40 wt %. The mixing of the oxide with the aqueous solution including a metal salt may be conducted using any known mixing methods in the art, and under ambient conditions.

Once sufficiently mixed, the mixture may be dried at a temperature of ranging from about 100° C. to 150° C. for about a time ranging from 1 to 4 hours. The dried mixture may then be calcined at a temperature ranging from about 200° C. to 1200° C. for a time ranging from about 1 to 6 hours. For example, the calcination temperature may have a lower limit of any one of 200, 250, 300, 350, 400 and 600° C., and/or an upper limit of any one of 350, 400, 450, 500, 600 and 1200° C., where any lower may be paired with any upper limit. Further, the calcination time may have a lower limit of any one of 1, 2, 3, and 4 hours and an upper limit of any one of 3, 4, 5 and 6, hours, where any lower limit may be paired with any mathematically compatible upper limit. Then the metal salt may be reduced in a gas phase reduction in a gas mixture comprising 1-100 vol % H₂ (e.g., 2-100 vol % H₂) in an inert carrier like N₂, at pressures ranging from 1-100 bar, with a flow rate sufficient to sweep out any moisture formed during the reduction. The gas phase reduction may be conducted at a temperature ranging from about 100° C. to 1200° C. for a time ranging from about 2 to 6 hours. During this reduction step, the metal salt is reduced to a metal nanoparticle. Once the reduction step is complete, the catalyst composition including the oxide support and the metallic material has thereby been synthesized.

In some, but not necessarily all embodiments, the gas phrase reduction is performed as follows. The metal salts are reduced to metal nanoparticles. If promoter materials are added, they may be added via similar wet impregnation steps at this time either before, after, or both before and after addition of metal salts. The promoter material may improve the performance of the catalyst and may be selected from materials including, but not limited to, cesium carbonate, barium nitrate, and/or potassium oxide. Then, a second reduction step, often key to the performance of the catalyst, may be performed in a hydrogen or hydrogen-containing atmosphere at temperatures between 200-1200° C. and total pressures between 1-100 bar for times between 3-48 hours. For example, the second reduction temperature may have a lower limit of any one of 200, 250, 300, 350, 400 and 600° C., and/or an upper limit of any one of 350, 400, 450, 500, 600 and 1200° C., where any lower may be paired with any upper limit. Further, the second reduction time may have a lower limit of any one of 3, 6, 12, and 24 hours and/or an upper limit of any one of 6, 12, 24 and 48 hours, where any lower limit may be paired with any mathematically compatible upper limit. Once the second reduction step is complete, the catalyst composition including the catalyst support and the metallic material has thereby been synthesized.

Another technique that may be employed for forming metallic materials for the catalyst is nanoparticle deposition of metal. In this technique, a single or multiple metal salts are mixed into a basic solution (e.g., pH of greater than 7, greater than or equal to 8, greater than or equal to 9, or greater) containing an organic molecule (e.g., an alcohol) and mixed for a set period of time. This solution may then be subjected to high temperature (e.g., greater than or equal to 500° C., greater than or equal to 800° C., greater than or equal to 1000° C., and/or up to 1500° C. or combinations thereof, such as 500-800° C. or 800-1000° C.) and optionally pressure (e.g., greater than 1 bar) for an extended period of time, for example, in an autoclave, to facilitate solvothermal synthesis of nanoparticles. The nanoparticles may form a colloidal solution into which the support can be introduced. Nanoparticle deposition can be encouraged by centrifuging the mixture for an extended period of time, for example, hours to several days. Centrifugation is followed by washing to remove excess salts, and the two steps are repeated multiple times until the desired level of deposition is met. Finally, the support may be dried in an oven over several hours to days. The support material can be weighed before and after the process to determine the exact % weight loading of the colloidal nanoparticles.

Any of a variety of techniques may be employed to prepare the support for the catalyst. For example, in some embodiments, the support (e.g., oxide support such as ceria support) may be synthesized hydrothermally. This may involve calcining a mixture of the metal precursors along with a combustible organic dispersant and surfactant in a solution in a stepwise manner at progressively increasing temperatures in the range of, for example, 50-1500° C. In some instances, an aging step is performed for several days following calcination to encourage the growth of crystallites. The size of the crystallites can be controlled by the length and temperature of the aging step, and a slow aging generally encourages better crystal structure. Finally, the support is recovered, washed and dried. The organic molecules may be removed by calcination in air at sufficiently high temperatures such as 500-1500° C. and for a period of several hours to days, depending on the composition and amount present. A common example of a synthesis via the hydrothermal method is mesoporous silica support materials, which are synthesized by sol-gel method starting from tetraalkoxysilanes followed by hydrothermal treatment.

As noted above, a sol gel method may be employed to prepare the support. In some embodiments, a specific sol gel technique called the Pechini method is employed. In some such embodiments, a chelating agent is used to form a complex with the metal ions. The chelating agent may reduce or prevent the precipitation of insoluble metal salts and allows for the formation of a homogenous precursor solution. Citric acid is one possible chelating agent because it has a high complexing ability and can bind with metals in different oxidation states. The metal salt and chelating agent are dissolved in a solvent, such as water or ethanol. The solution is then heated to form a gel, which is dried and then calcined at high temperature (for example, 500-1500° C.) to form the metal oxide. This synthesis can produce relatively pure metal oxides, with controlled particle size and excellent thermal stability. This process can also be used to produce complex oxide systems, such as doped metal oxides (e.g., doped ceria) and/or mixed metal oxides.

Another technique that can be used to prepare the support is flameless pyrolysis. Flameless pyrolysis can be used for the synthesis of inorganic materials, such as ceramic precursors, metal oxides and/or nanoparticles, and other inorganic compounds. This process may involve the pyrolysis of a mixture of precursor materials (e.g. metallic salts including but not limited to citrates, oxalates and nitrates) in the absence of oxygen, leading to the formation of a solid inorganic material. The precursor material can be in the form of a liquid or a solid, and may be heated to a high temperature in a controlled atmosphere to initiate the pyrolysis reaction. The reaction may take place in a flow reactor, including but not limited to a pulsation reactor, where the precursor is introduced into the reactor and heated to the desired temperature (e.g. 500° C., 1000° C., 1500° C.). In the absence of an open flame, and optionally in the presence of pulsation, the precursor material is broken down into its constituent elements or compounds, which then recombine to form the desired final inorganic product. The final product can be in the form of a powder, a coating, or a bulk material depending on the nature of the precursor and the reaction conditions.

After synthesis, the catalyst composition may be further processed via milling and sieving to achieve a desired particle size. The catalyst composition may then be processed with a binder to achieve an agglomerate/granule size as described above.

### Method of Catalyzing Gas Phase Reactions

As noted above, the heterogeneous catalyst composition described herein may be used in methods of catalyzing various gas phase reactions. Examples of gas phase reactions that may be catalyzed by the catalyst described herein include but are not limited to ammonia synthesis.

Embodiments disclosed herein relate to a process for production of ammonia from hydrogen and nitrogen gases may use the supported catalyst composition. Ammonia production volume may be less than 10,000 tons/day, less than 1000 tons/day, or less than 100 tons/day.

Thus, some embodiments disclosed herein relate to a method of synthesizing ammonia using the described heterogeneous catalysis composition above. The method may include contacting a catalyst composition with one or more precursor gases (which may be feedstock gases). The precursor gases may be in the form of a gas stream (e.g., comprising reactants such as nitrogen and hydrogen gases). The method may further comprises producing ammonia at a surface of the catalyst composition. The catalytic production of ammonia may be induced and/or accelerated via heating (e.g., heating the reaction environment at a temperature in a range described above and/or below). Alternatively or additionally, the catalytic production of ammonia may be induced and/or accelerated via application of pressure to the reaction mixture and/or catalyst (e.g., to a pressure in a range described above and/or below).

The method may include contacting a catalyst composition with a precursor gas stream comprising nitrogen and hydrogen gases and then producing ammonia at a surface of the catalyst composition. The supported catalyst composition may facilitate single-pass yields of ammonia synthesis from hydrogen gas and nitrogen gas precursors at a 3:1 H₂:N₂ ratio in excess of 5% at 350° C., 75 bar total pressure, and 5000 h⁻¹ gas hourly space velocity (GHSV). The supported catalyst composition may facilitate single-pass yields of ammonia synthesis from hydrogen gas and nitrogen gas precursors at a 3:1 H₂:N₂ ratio in excess of in excess of 5%, in excess of 8%, in excess of 10%, in excess of 15%, or higher at 350° C., 75 bar total pressure, and 5000 h⁻¹ gas hourly space velocity (GHSV). In some embodiments supported catalyst composition may facilitate single-pass yields of ammonia synthesis from hydrogen gas and nitrogen gas precursors at a 3:1 H₂:N₂ ratio of up to 20%, up to 25%, up to 30%, or higher at 350° C., 75 bar total pressure, and 5000 h⁻¹ gas hourly space velocity (GHSV). In some embodiments supported catalyst composition may facilitate single-pass yields of ammonia synthesis from hydrogen gas and nitrogen gas precursors at a 3:1 H₂:N₂ ratio in excess of 3%, in excess of 5%, in excess of 8%, in excess of 10%, in excess of 15%, or higher at 350° C., 75 bar total pressure, and 10000 h⁻¹ gas hourly space velocity (GHSV). In some embodiments supported catalyst composition may facilitate single-pass yields of ammonia synthesis from hydrogen gas and nitrogen gas precursors at a 3:1 H₂:N₂ ratio of up to 20%, up to 25%, or higher at 350° C., 75 bar total pressure, and 10000 h⁻¹ gas hourly space velocity (GHSV). Combinations of these ranges are possible.

Some aspects of this disclosure relate to reactors for gas phase catalysis. The reactor may comprise, for example, a reactor vessel. The vessel may comprise an enclosure establishing an interior volume that can be at least partially filled with reactants (e.g., precursor gases and/or catalysts). The vessel may be configured to contain the catalyst composition. For example, the catalyst composition may be present in the reactor vessel as or as part of a bed. In some embodiments, the reactor comprises one or more inlets for receiving one or more precursor gases (e.g., by being fluidically connected to a source of the one or more precursor gases). The one or more precursor gases may be supplied in a single stream (comprising multiple precursor gases) to a single inlet. For example, a single stream comprising both nitrogen gas and hydrogen gas may be supplied to an inlet of the reactor. Alternatively, the reactor may comprise two or more inlets, each of which may receive a portion but not all of the precursor gases. For example, the reactor may comprises a first inlet that receives nitrogen gas and a second inlet that receives hydrogen gas. The reactor vessel may be configured to receive the one or more precursor gases (e.g., from the one or more inlets). For example, one or more inlets may be fluidically to the vessel.

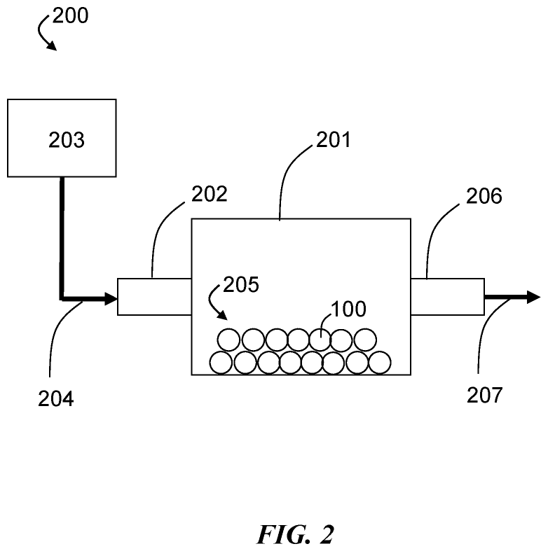

FIG. 2 shows a schematic cross-sectional diagram of reactor 200, according to some embodiments. Reactor 200 may comprises reactor vessel 201 fluidically connected to inlet 202, which is in turn fluidically connected to source 203 of precursor gas stream 204 (e.g., via a conduit). Reactor vessel 201 contains bed 205 comprising catalyst composition 100, which may be any of the catalyst compositions described in this disclosure. In some embodiments, the reactor further comprises an outlet, which may be configured to output a product gas (e.g., as a product gas stream). The product gas may comprise, for example, ammonia gas (NH₃). As an example, in FIG. 2, reactor 200 may further comprise outlet 206 fluidically connected to reactor vessel 201 and configured to output product gas 207.

Commercial ammonia reaction conditions are as follows. The ammonia synthesis may be conducted in any commercial reactor known in the art. However, it should be understood that the ammonia synthesis (or any of other gas phase catalytic reaction described in this disclosure) need not be limited to commercial reactors. In some embodiments, the contacting and producing steps may be performed in a reactor selected from the group consisting of a batch reactor, a semibatch reactor, a continuous stirred tank reactor, a plug-flow reactor, a trickle-bed reactor, a fixed bed reactor, a moving bed reactor, a rotating bed reactor, a slurry reactor, a tubular reactor, a radial and axial packed bed reactor, a membrane reactor, and a fluidized bed reactor.

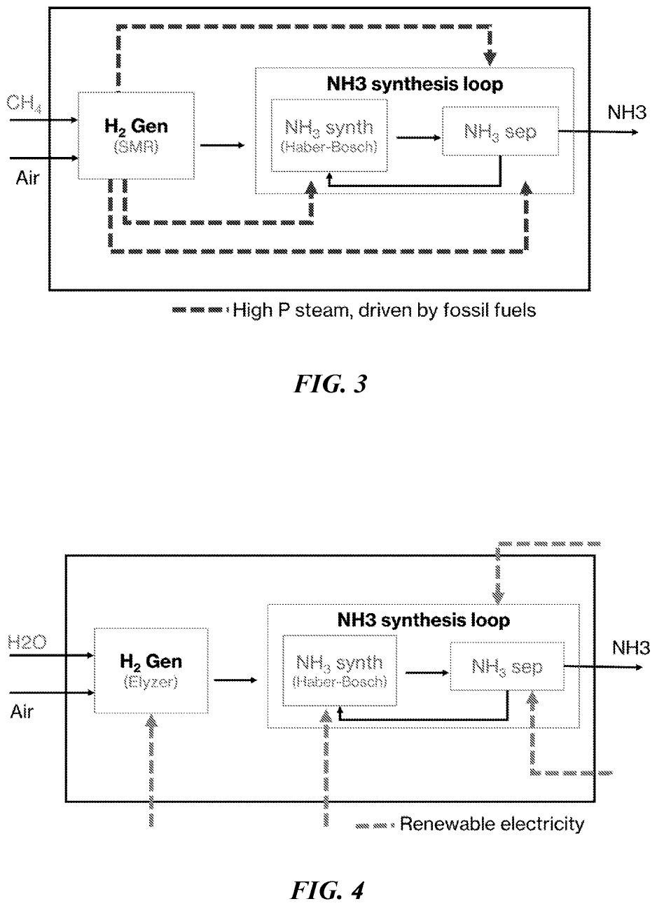

As discussed herein, in some embodiments, an ammonia process can be divided into H₂ synthesis and a NH₃ synthesis loop. More specifically, FIG. 3 depicts a conventional gray ammonia process according to an embodiment of the present disclosure. CH₄ and air may be introduced for H₂ synthesis. High pressure steam driven by fossil fuels may be employed, and the NH₃ synthesis loop may include NH₃ synthesis which may lead to NH₃ separation, thereby producing NH₃. FIG. 4 depicts a zero-carbon green ammonia process according to an embodiment of the present disclosure. Water and air may be introduced for H₂ synthesis. Renewable electricity may be employed, and the NH₃ synthesis loop may include NH₃ synthesis which may lead to NH₃ separation, thereby producing NH₃. Other methods for forming precursor gases such as nitrogen and hydrogen gases may also be employed.

The ammonia synthesis may be conducted at standard temperatures and pressures for ammonia production. However, advantageously, the catalyst described herein may allow for lower temperatures and pressures to be utilized. For example, the temperature during ammonia production may range from 0° C. to 500° C. As another example, the temperature during ammonia production may range from 0° C. to 450° C. The temperature may have a lower limit of any one of 0° C., 5° C., 10° C., 20° C., 50° C., 100° C., and 200° C. and an upper limit of any one of 150° C., 200° C., 300° C., 400° C., 450° C., and 500° C., where any lower limit may be paired with any mathematically compatible upper limit. The pressure during ammonia production may range from 1 bar to 200 bar. For example, the pressure may have a lower limit of any one of 1, 2, 5, 10, 20, 30, 50 and 75 bar and/or an upper limit of any one of 75, 100, 125, 150, and 200 bar, where any lower limit may be paired with any mathematically compatible upper limit.

The ammonia synthesis may involve flowing hydrogen and nitrogen gases as feedstocks over the catalyst under reactor conditions in certain atomic ratios. Some embodiments include feedstock H₂:N₂ atomic ratios of between 1-3:1 at the point where the feedstocks make contact with the catalyst. The catalyst described herein may not require an electric field. However, either a DC or AC electric field, or electromagnetic radiation, including but not limited to either microwaves or visible light may be used to improve catalyst efficiency. As such, in some embodiments, the contacting and producing steps of the method of producing ammonia are conducted in the absence of an applied electric field applied to the catalyst composition. In other embodiments, the contacting and/or producing steps are conducted with either a DC or AC electric field, or electromagnetic radiation, including but not limited to either microwaves or visible light applied to the catalyst composition. For example, in some embodiments, the contacting and producing steps are conducted with an electric field applied to the catalyst composition. The electric field may be either a DC or an AC electric field.

The method herein may be performed such that the product (e.g., ammonia) is generated with a single-pass productivity of greater than or equal to 0.01 millimoles of product per gram of catalyst per hour (mmol/g/h), greater than or equal to 0.1 mmol/g/h, greater than or equal to 0.2 mmol/g/h, greater than or equal to 0.5 mmol/g/h, greater than or equal to 1 mmol/g/h, greater than or equal to 2 mmol/g/h, greater than or equal to 3 mmol/g/h, greater than or equal to 5 mmol/g/h, and/or up to 8 mmol/g/h, up to 10 mmol/g/h, up to 20 mmol/g/h, up to 50 mmol/g/h, up to 100 mmol/g/h, up to 1000 mmol/g/h, or more under the conditions with which the method is performed (e.g., at any of the temperature, pressure, feedstock mixtures, and flow rates described in this disclosure). For example, these productivities may be achieved under conditions of 200-500° C., 1-200 bar total pressure, and 5000-100,000 h⁻¹ GHSV.

The catalyst may achieve a suitable rate of ammonia production for standard commercial processes. Specifically, the catalyst may achieve a rate of ammonia production of at least 1 mmol product/gram catalyst/hour for a single pass over a single bed under standard commercial reactor space velocities. The rate of ammonia production may be at least 2, or at least 5, or at least 10, or at least 20, or at least 50, or at least 100, or at least 120, or at least 300, or at least 500 or at least 1000 mmol product/gram catalyst/hour for a single pass over a single bed under standard commercial reactor space velocities. For example, these productivities may be achieved under conditions of 200-500° C., 1-200 bar total pressure, and 5000-100,000 h⁻¹ GHSV.

After the ammonia has been produced, the method may further include separating ammonia from the precursor gas stream via a technique selected from the group consisting of condensation, pressure swing adsorption, temperature swing adsorption, microwave swing adsorption, vacuum swing adsorption, and combinations thereof.

The support material may comprise vacancies, dopants, impurities, and combinations thereof in an amount of not greater than 15 atomic %. The support material may have a BET surface area of at least 5 m²/g. The supported catalyst composition may comprise from 0.1 to 40% by weight of the metallic material.

In some embodiments, the method further comprises generating hydrogen gas to be used as a precursor gas in the ammonia production process. The hydrogen gas may be produced in any of a variety of ways. For example, the hydrogen gas may be produced via electrolysis or from fossil fuels. When electrolysis is used, suitable methods include but are not limited to alkali electrolysis, polymer electrolyte membrane (PEM) electrolysis, and/or solid oxide electrolyzer cell (SOEC) electrolysis. When hydrogen is produced from fossil fuels, suitable production methods include but are not limited to the steam methane reforming (SMR) process, the water-gas shift (WGS) process, and the coal-gasification process. These processes may or may not be integrated into the ammonia synthesis production process.

In some embodiments, the method further comprises generating the nitrogen gas to be used as a precursor gas in the ammonia production process. Nitrogen may be produced via air using conventional air separation processes. These processes may or may not be integrated into the ammonia synthesis production process.

In some embodiments, the method may further comprise supplying the energy needed to drive the ammonia synthesis processes. The energy may be provided in any of a variety of ways. For example, the energy may be provided via renewable energy processes or by using waste heat from the ammonia production process to further reduce the overall carbon footprint of the ammonia synthesis. For example, electricity generated via renewable energy generation techniques such as solar power, wind power, and nuclear power. Additionally, waste heat may be recovered from the steam methane reforming (SMR) process, the water-gas shift (WGS) process, and the coal-gasification process. These processes may or may not be integrated into the ammonia synthesis production process.

The following examples are intended to illustrate certain embodiments of the present invention, but do not exemplify the full scope of the invention. The examples provided below relate to specific heterogeneous catalysts for use in a thermochemical ammonia synthesis process. It should be clear to anyone skilled in the art to extend this example to any of the other heterogeneous catalysts and optionally promoter materials described herein for use in a thermochemical ammonia synthesis process.

### Example 1

### Sample 1: Cs-Promoted RuFe (5% Wt) on Ceria.

Ceria (CeO₂) with a BET surface area of 180 m²/g was purchased and used as a support. 1.8 g of ceria was impregnated using the incipient wetness technique with 1.08 ml of an aqueous solution containing Ru(III) nitrosyl nitrate and Fe(III) nitrate nonahydrate with a 1:1 molar ratio at concentrations chosen so that the total mass of Ru and Fe ions in solution were 68.2 mg and 37.7 mg respectively. The catalyst was then dried in a convection oven for 15 h at 80° C. The catalyst was then subject to a first gas-phase reduction under forming gas (5% H₂/95% N₂) for 4 h at 400° C. at 1 bar.

The Cs promoter was then added to the above in a subsequent impregnation step, again using the incipient wetness technique. In detail, 0.99 ml of an aqueous solution containing Cs₂CO₃ at a concentration equivalent to 0.21 g of Cs ions was added to the precursor described in the previous paragraph. The promoted catalyst was then dried under vacuum for 2 h at 80° C.

In a final gas-phase reduction step, the promoted catalyst was then transferred to an ammonia microreactor and reduced in a pure hydrogen atmosphere for 24 h at 500° C. at 10 bar. To measure the yield for ammonia synthesis, hydrogen gas and nitrogen gas precursors were then flowed over the completed catalyst in the microreactor at a 3:1 H₂:N₂ ratio at 350° C., 75 bar total pressure, and 5000 h⁻¹ GHSV.

### Comparative Sample 1: Cs-Promoted Ru (5% Wt) on Ceria.

Ceria (CeO₂) with a BET surface area of 180 m²/g was purchased and used as a support. 1.8 g of ceria was impregnated using the incipient wetness technique with 1.08 ml of an aqueous solution containing Ru(III) nitrosyl nitrate at a concentration chosen so that the total mass of Ru ions in solution was 106 mg. The catalyst was then dried in a convection oven for 15 h at 80° C. The catalyst was then subject to a first gas-phase reduction under forming gas (5% H₂/95% N₂) for 4 h at 400° C. at 1 bar.

The Cs promoter was then added to the above in a subsequent impregnation step, again using the incipient wetness technique. In detail, 0.99 ml of an aqueous solution containing Cs₂CO₃ at a concentration equivalent to 0.21 g of Cs ions was added to the precursor described in the previous paragraph. The promoted catalyst was then dried under vacuum for 2 h at 80° C.

In a final gas-phase reduction step), the promoted catalyst was then transferred to an ammonia microreactor and reduced in a pure hydrogen atmosphere for 24 h at 500° C. at 10 bar. To measure the yield for ammonia synthesis, hydrogen gas and nitrogen gas precursors were then flowed over the completed catalyst in the microreactor at a 3:1 H₂:N₂ ratio at 350° C., 75 bar total pressure, and 5000 h⁻¹ GHSV.

### Comparative Sample 2: Cs-Promoted Ru (5% Wt) on Ceria.

Ceria (CeO₂) with a BET surface area of 180 m²/g was purchased and used as a support. 1.8 g of ceria was impregnated using the incipient wetness technique with 1.08 ml of an aqueous solution containing Ru(III) nitrosyl nitrate at a concentration chosen so that the total mass of Ru ions in solution was 106 mg. The catalyst was then dried in a convection oven for 15 h at 80° C. The catalyst was then subject to a first gas-phase reduction under forming gas (5% H₂/95% N₂) for 4 h at 400° C. at 1 bar.

The Cs promoter was then added to the above in a subsequent impregnation step, again using the incipient wetness technique. In detail, 0.99 ml of an aqueous solution containing Cs₂CO₃ at a concentration equivalent to 0.21 g of Cs ions was added to the precursor described in the previous paragraph. The promoted catalyst was then dried under vacuum for 2 h at 80° C.

In a final gas-phase reduction step, the promoted catalyst was then transferred to an ammonia microreactor and reduced in a pure hydrogen atmosphere for 3 h at 500° C. at 1 bar. To measure the yield for ammonia synthesis, hydrogen gas and nitrogen gas precursors were then flowed over the completed catalyst in the microreactor at a 3:1 H₂:N₂ ratio at 350° C., 75 bar total pressure, and 5000 h⁻¹ GHSV.

### Comparative Sample 3: Cs-Promoted RuFe (5% Wt) on Ceria, Key Reduction Step: H₂/500° C./1 Bar/3 h.

Ceria (CeO₂) with a BET surface area of 180 m²/g was purchased and used as a support. 1.8 g of ceria was impregnated using the incipient wetness technique with 1.08 ml of an aqueous solution containing Ru(III) nitrosyl nitrate and Fe(III) nitrate nonahydrate with a 1:1 molar ratio at concentrations chosen so that the total mass of Ru and Fe ions in solution were 68.2 mg and 37.7 mg respectively. The catalyst was then dried in a convection oven for 15 h at 80° C. The catalyst was then subject to a first gas-phase reduction under forming gas (5% H₂/95% N₂) for 4 h at 400° C. at 1 bar.

The Cs promoter was then added to the above in a subsequent impregnation step, again using the incipient wetness technique. In detail, 0.99 ml of an aqueous solution containing Cs₂CO₃ at a concentration equivalent to 0.21 g of Cs ions was added to the precursor described in the previous paragraph. The promoted catalyst was then dried under vacuum for 2 h at 80° C.

In a final gas-phase reduction step, the promoted catalyst was then transferred to an ammonia microreactor and reduced in a pure hydrogen atmosphere for 3 h at 500° C. at 1 bar. To measure the yield for ammonia synthesis, hydrogen gas and nitrogen gas precursors were then flowed over the completed catalyst in the microreactor at a 3:1 H₂:N₂ ratio at 350° C., 75 bar total pressure, and 5000 h⁻¹ GHSV.

Table 1 is a summary of data obtained from the examples discussed herein. Table 1 provides single-pass yields for selected metal-supported heterogeneous catalysts (5% RuFe (1:1 molar ratio of Ru:Fe) on CeO₂, promoted with Cs) for ammonia synthesis from hydrogen gas and nitrogen gas precursors at a 3:1 H₂:N₂ ratio in excess of 5% at 350° C., 75 bar total pressure, and 5000 h⁻¹ GHSV. Note the improved yield of the RuFe (molar ratio 1:1) catalyst after the >6 hr (24 h) reduction under hydrogen at 500° C./10 bar vs. the yield after 3 h at 500° C./1 bar.

TABLE 1
Single pass ammonia synthesis yields

| Metal | Support | Promoter | Reduction Step | Yield |
|---|---|---|---|---|
| Ru (5% wt) | CeO₂ | Cs | H₂/500° C./10 bar/24 h | 2.0% |
| RuFe (5% wt) | CeO₂ | Cs | H₂/500° C./10 bar/24 h | 8.2% |
| Ru (5% wt) | CeO₂ | Cs | H₂/500° C./1 bar/3 h | 2.4% |
| RuFe (5% wt) | CeO₂ | Cs | H₂/500° C./1 bar/3 h | 3.5% |

### Example 2

This Example provides experimental data demonstrating improved ammonia synthesis productivity for various catalyst compositions employing a doped ceria support as opposed to an undoped ceria support.

Table 2 (a) shows a comparison of compositions employing a Ru metal catalyst on undoped ceria and on ceria doped with 10% Fe. The ammonia synthesis reaction was performed from hydrogen gas and nitrogen gas precursors at a 3:1 H₂:N₂ ratio at 350° C., 75 bar total pressure, and 10000 h⁻¹ GHSV. The “Ru/undoped ceria” sample was prepared by forming the catalyst on commercial ceria using the incipient wetness technique described above in this disclosure, with the Ru metal being present in an amount of 5 wt % by weight of the composition and using cesium as a promoter. The surface area of each catalyst composition was estimated to be 180 m²/g. The “Ru/10% Fe-doped CeO2” sample was prepared by synthesizing iron-doped ceria using the hydrothermal technique described above in this disclosure (resulting in 10% Fe in the ceria), and then forming the catalyst on the synthesized ceria using the incipient wetness technique described above, with the Ru metal being present in an amount of 5 wt % by weight of the composition, and using barium and potassium as promoters. The surface area of each catalyst composition was estimated to be 65 m²/g.

TABLE 2a
Ammonia yield and productivity.

| | | productivity |
|---|---|---|
| | Yield % | mmol/g/h |
| Ru/undoped ceria | 2.17 | 2.6 |
| Ru/10% Fe-doped CeO2 | 8 | 5.83 |

Table 2 (b) shows a comparison of compositions employing a Fe metal catalyst on undoped ceria and on ceria doped with 10% Fe. The ammonia synthesis reaction was performed from hydrogen gas and nitrogen gas precursors at a 3:1 H₂:N₂ at 400° C., 85 bar total pressure, and 15000 h⁻¹ GHSV. The “Fe/undoped ceria” sample was prepared by forming the catalyst on commercial ceria using the incipient wetness technique described above in this disclosure, with the Fe metal being present in an amount of 2 wt % by weight of the composition and using potassium as a promoter. The “Fe/10% Fe-doped-CeO₂” sample was prepared by synthesizing iron-doped ceria using the hydrothermal technique described above in this disclosure (resulting in 10% Fe in the ceria), and then forming the catalyst on the synthesized ceria using the incipient wetness technique described above, with the Fe metallic material being present in an amount of 5 wt % by weight of the composition, and using potassium as a promoter, resulting in a catalyst composition having an overall chemical formula of Ce_{0.74}Fe_{0.26}O₍₂₋ₓ₎, where x represents the level of oxygen vacancy (which was not measured in this Example). The surface area of each catalyst composition was estimated to be 65 m²/g.

TABLE 2b
Ammonia yield and productivity

| | | productivity |
|---|---|---|
| | Yield % | mmol/g/h |
| Fe/undoped ceria | 2.52 | 3.8 |
| Fe/10% Fe-doped CeO2 | 7.2 | 17.7 |

Table 2 (c) shows a comparison of compositions employing a 1:1 RuFe metal catalyst on undoped ceria and on ceria doped with 10% Fe. The ammonia synthesis reaction was performed from hydrogen gas and nitrogen gas precursors at a 3:1 H₂:N₂ ratio at 350° C., 75 bar total pressure, and 10000 h⁻¹ GHSV. The “RuFe/undoped ceria” sample was prepared by forming the catalyst on commercial ceria using the incipient wetness technique described above in this disclosure, with the RuFe metal catalyst being present in a total amount of 5 wt % by weight of the composition and using cesium as a promoter. The surface area of the catalyst composition was estimated to be 180 m²/g. The “RuFe/10% Fe-doped-CeO₂” sample was prepared by synthesizing iron-doped ceria using the hydrothermal technique described above in this disclosure (resulting in 10% Fe in the ceria), and then forming the catalyst on the synthesized ceria using the incipient wetness technique described above, with the RuFe metal being present in an amount of 5 wt % by weight of the composition, and using barium and potassium as promoters. The surface area of the catalyst composition was estimated to be 65 m²/g.

TABLE 2c
Ammonia yield and productivity

| | | productivity |
|---|---|---|
| | Yield % | mmol/g/h |
| RuFe/undoped ceria | 5.1 | 6.9 |
| RuFe/10% Fe-doped CeO2 | 4.44 | 9.1 |

From the results in this Example, it was observed and recognized that the presence of a dopant in ceria such as iron can enhance the performance of a catalyst composition for ammonia synthesis in terms of productivity and yield, especially for catalysts comprising predominantly Ru only or predominantly Fe only.

### Example 3

This Example provides experimental data demonstrating improved ammonia synthesis productivity for certain catalyst compositions employing a doped ceria support or a perovskite support.

Table 3 (a) shows a comparison of compositions employing a 1:1 RuFe metal catalyst on undoped ceria and on ceria doped with 10% Fe. The ammonia synthesis reaction was performed from hydrogen gas and nitrogen gas precursors at a 3:1 H₂:N₂ ratio at 350° C., 75 bar total pressure, and 10000 h⁻¹ GHSV. The “RuFe/undoped ceria” sample was prepared by forming the catalyst on commercial ceria using the incipient wetness technique described above in this disclosure, with the RuFe metal catalyst being present in a total amount of 5 wt % by weight of the composition and using cesium as a promoter. The surface area of the catalyst composition was estimated to be 180 m²/g. The remaining entries were prepared by synthesizing doped ceria using the hydrothermal technique described above in this disclosure (resulting in the doping indicated in table 3(a)), and then forming the catalyst on the synthesized ceria using the incipient wetness technique described above, with the RuFe metal being present in an amount of 5 wt % by weight of the composition, and using barium and potassium as promoters. The surface area of each of the remaining catalyst compositions was estimated to be 65 m²/g except for the “RuFe/10% Y-doped CeO₂” entry, which had an estimated surface area of 100 m²/g.

TABLE 3a
Ammonia yield and productivity.

| | | productivity |
|---|---|---|
| | Yield % | mmol/g/h |
| RuFe/undoped ceria | 5.1 | 6.9 |
| RuFe/10% Fe-doped CeO2 | 4.44 | 9.1 |
| RuFe/20% Fe-doped CeO2 | 5.91 | 8.7 |
| RuFe/10% Y-doped CeO2 | 4.7 | 7.9 |
| RuFe/Ce0.5Zr0.3Fe0.2O2 | 6.27 | 7.3 |
| RuFe/Ce0.5Zr0.3Mg0.2O2 | 5.11 | 5.6 |
| RuFe/Mn-CeO2 | 0.6 | 2.2 |

Table 3 (b) shows a comparison of compositions employing an Fe or Co metal catalyst on undoped ceria and on ceria doped with various amounts of Fe or on a perovskite. The ammonia synthesis reaction was performed from hydrogen gas and nitrogen gas precursors at a 3:1 H₂:N₂ ratio at 400° C., 85 bar total pressure, and 15000 h⁻¹ GHSV. The “Fe/undoped ceria” sample was prepared by forming the catalyst on commercial ceria using the incipient wetness technique described above in this disclosure, with the Fe metal catalyst being present in a total amount of 5 wt % by weight of the composition and using cesium as a promoter. The surface area of the catalyst composition was estimated to be 180 m²/g. The remaining entries were prepared by synthesizing doped ceria (using the hydrothermal technique described above) or a BaCeO₃ perovskite (using the Pechini sol-gel technique described above in this disclosure) (resulting in the doping indicated in table 3(b)), and then forming the catalyst on the synthesized ceria or the perovskite using the incipient wetness technique described above, with the Fe or Co metal being present in an amount of 5 wt % by weight of the composition for the Fe catalyst entries and 66.7 wt % by weight of the composition for the Co catalyst entry, and using potassium as a promoter (except for the Co—BaCeO₃ perovskite sample, which did not use an electronic promoter). The surface area of each catalyst composition was estimated to be 65 m²/g, except for the Co—BaCeO₃ sample, for which a surface area estimation was not made.

TABLE 3b
Ammonia yield and productivity.

| | | productivity |
|---|---|---|
| | Yield % | mmol/g/h |
| Fe/undoped ceria | 2.17 | 2.6 |
| Fe/10% Fe-doped CeO2 | 7.2 | 17.7 |
| Fe/20% Fe-doped CeO2 | 6.3 | 15.7 |
| Fe/25% Fe-doped CeO2 | 6.93 | 15.7 |
| Fe/30% Fe-doped CeO2 | 7.36 | 14.9 |
| Fe/35% Fe-doped CeO2 | 6.44 | 13.2 |
| Co/BaCeO3 | 0.76 | 1 |

The experimental results indicated that the type and amount of dopant affects yield and productivity for ammonia synthesis.

### Example 4

This Example provides experimental data demonstrating ammonia synthesis productivity for certain catalyst compositions employing a perovskite support.

Table 4 shows a comparison of compositions employing a Co, Ru, or 1:1 RuFe metal catalyst on various perovskite supports. The ammonia synthesis reaction was performed from hydrogen gas and nitrogen gas precursors at a 3:1 H₂:N₂ at 350° C., 75 bar total pressure, and 10000 h⁻¹ GHSV. Each entries was prepared by synthesizing a perovskite using the Pechini sol-gel technique described above in this disclosure and then forming the catalyst on the synthesized perovskite using the incipient wetness technique described above, with the metal catalyst being present in an amount of 0.5 wt % by weight of the composition for the RuFe catalyst entries, 5 wt % for the Ru entry, and 66.7 wt % by weight of the composition for the Co catalyst entry. The surface area of each catalyst composition was estimated to be 20 m²/g, except for the Co—BaCeO₃, Ru/LaTiO₃, and RuFe/LaTiO₃ samples, for which a surface area estimation was not made. The Ru/LaTiO₃ and RuFe/LaTiO₃ samples used cesium as a promoter; the remaining entries did not use an electronic promoter.

TABLE 4
Ammonia synthesis and productivity.

| | | productivity |
|---|---|---|
| | Yield % | mmol/g/h |
| Co/BaCeO3 | 0.76 | 1 |
| Ru/Ba/LaCeOx | 0.54 | 0.5 |
| RuFe/Ba/LaCeOx | 0.4 | 0.6 |
| Ru/LaTiO3 | 0.26 | 0.1 |
| RuFe/LaTiO3 | 0.02 | 0.03 |

These experimental results demonstrated that perovskites can be used as supports for active catalysts.

### Example 5

This Example provides experimental data demonstrating ammonia synthesis productivity for catalyst compositions employing combinations of Ru, Fe, and an additional transition metal on a commercial ceria support.

Table 5 shows a comparison of compositions employing a 48:50:2 (on a molar basis) RuFeT metal catalyst on undoped ceria, where T is one of Co, Mn, or Mo. The ammonia synthesis reaction was performed from hydrogen gas and nitrogen gas precursors at a 3:1 H₂:N₂ ratio at 350° C., 75 bar total pressure, and 10000 h⁻¹ GHSV. The entries were prepared by forming the catalysts on commercial ceria using the incipient wetness technique described above, with the metal catalysts being present in an amount of 5 wt % by weight of the composition, and using barium and potassium as promoters. The surface area of each catalyst composition was estimated to be 180 m²/g.

TABLE 5
Ammonia synthesis and productivity.

| | | productivity |
|---|---|---|
| | Yield % | mmol/g/h |
| RuFeCo 48:50:2 | 4.8 | 5.6 |
| RuFeMn 48:50:2 | 3.3 | 5.4 |
| RuFeMo 48:50:2 | 3.3 | 3.8 |

These experimental results demonstrate an additional transition metal beyond Ru and Fe, when present, can affect ammonia synthesis yield and productivity.

### Example 6

This Example provides experimental data demonstrating ammonia synthesis using catalysts of 1:1 RuFe on Ce_{0.5}Zr_{0.3}Y_{0.2}O₍₂₋ₓ₎ under different processing conditions.

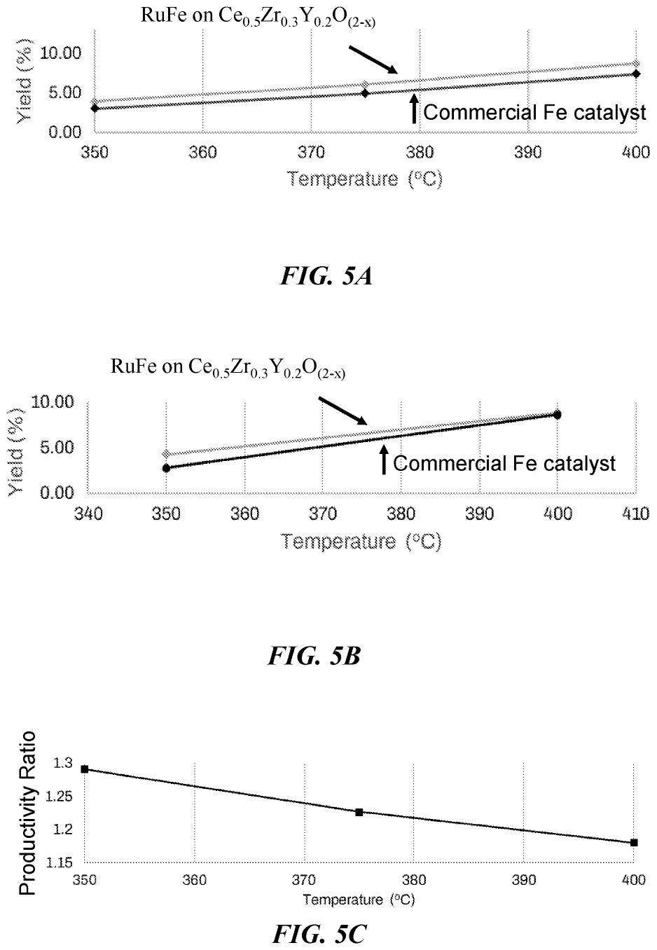

FIGS. 5A-5C show ammonia yield versus temperature at 15000 h⁻¹ GHSV (FIG. 5A), ammonia yield versus temperature at 10000 h⁻¹ GHSV (FIG. 5B), and a ratio of the productivity of the RuFe on Ce_{0.5}Zr_{0.3}Y_{0.2}O₍₂₋ₓ₎ catalyst divided by the productivity of a commercial iron catalyst at various temperatures (FIG. 5C). The ammonia synthesis reaction was performed from hydrogen gas and nitrogen gas precursors at a 3:1 H₂:N₂ ratio at 350° C., 85 bar total pressure, and 10000 h⁻¹ GHSV or 15000 h⁻¹ GHSV. The catalyst composition was prepared using the hydrothermal technique described above in this disclosure, and then forming the catalyst on the synthesized ceria using the incipient wetness technique described above, with the RuFe metal being present in an amount of 5 wt % by weight of the composition, and using barium and potassium as promoters. The experimental data demonstrated ammonia yields and productivity for the catalyst composition of this disclosure at least as high as that of the commercial iron catalyst compositions and in some instances significantly higher, especially at relatively low temperatures.

### Example 7

This Example provides experimental data demonstrating ammonia synthesis using a catalyst of Fe on 10% Fe-doped CeO₂ under different processing conditions.

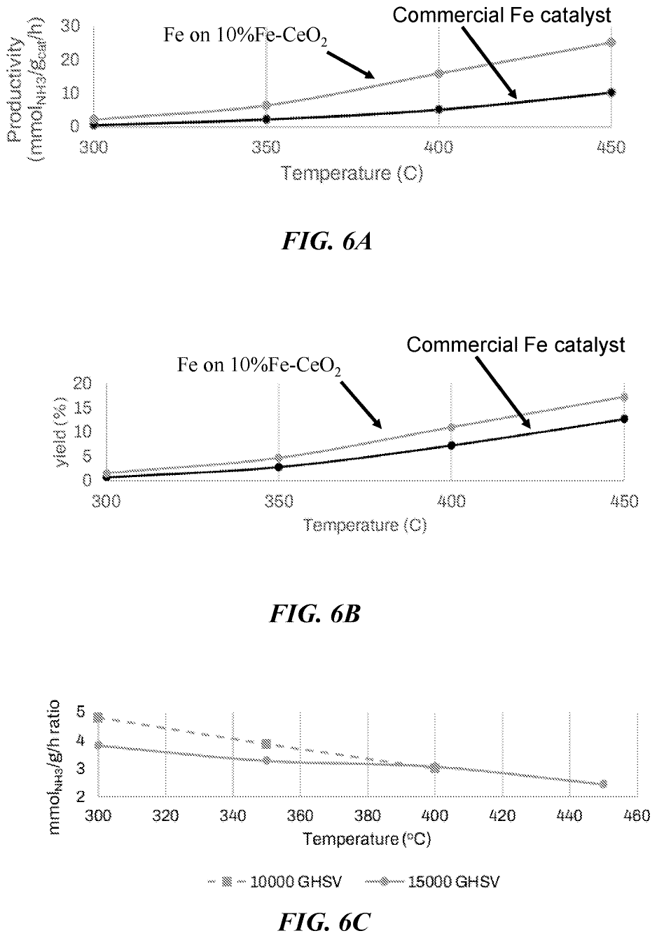

FIGS. 6A-6C show ammonia productivity versus temperature for the Fe on 10% Fe-doped CeO₂ catalyst composition and a commercial iron catalyst (the latter as a comparative example) (FIG. 6A), ammonia yield versus temperature (FIG. 6B), and a ratio of the productivity of the Fe on 10% Fe-doped CeO2 catalyst divided by the productivity of a commercial iron catalyst at various temperatures and conditions (FIG. 6C). The ammonia synthesis reaction was performed from hydrogen gas and nitrogen gas precursors at a 3:1 H₂:N₂ ratio, 85 bar total pressure, and 10000 h⁻¹ GHSV or 15000 h⁻¹ GHSV. The catalyst composition was prepared using the hydrothermal technique described above in this disclosure, and then forming the catalyst on the synthesized ceria using the incipient wetness technique described above, with the Fe metal being present in an amount of 5 wt % by weight of the composition, and using potassium as a promoter. The surface area of each catalyst composition was estimated to be 65 m²/g. The experimental data demonstrated ammonia yields and productivity for the catalyst composition of this disclosure at least as high as that of the commercial iron catalyst compositions and in some instances significantly higher, especially at higher low temperatures. It was also measured that the experimental activation barrier for the Fe on 10% Fe-doped CeO₂ catalyst composition was 116 KJ/mol, which was lower than the measured activation barrier for ammonia synthesis for the 1st generation iron commercial catalyst (138 KJ/mol) and the second generation commercial iron catalyst (127 KJ/mol), consistent with superior catalytic performance.

### Example 8

This Example provides experimental data demonstrating ammonia synthesis productivity and yields for catalyst compositions of varying relative molar ratios of Ru and Fe on ceria supports.

Table 6 shows a comparison of compositions employing a various Ru:Fe molar ratios ranging from 70:30 Ru:Fe to 30:70 Ru:Fe metal catalyst on undoped ceria. The ammonia synthesis reaction was performed from hydrogen gas and nitrogen gas precursors at a 3:1 H₂:N₂ ratio at 350° C., 75 bar total pressure, and 10000 h⁻¹ GHSV. The samples were prepared by forming the catalyst on commercial ceria using the incipient wetness technique described above in this disclosure but with different relative ratios of the Ru and Fe precursor salts, with each RuFe metal catalyst being present in a total amount of 5 wt % by weight of the composition and using cesium as a promoter. The surface area of each catalyst composition was estimated to be 180 m²/g.

TABLE 6
Ammonia yields, productivity, and productivity per gram of Ru.

| | | productivity | productivity |
|---|---|---|---|
| Metal | Yield % | mmol/g/h | mmol/g Ru/h |
| Ru:Fe 70:30 | 3.66 | 4.1 | 102 |
| Ru:Fe 60:40 | 4.8 | 5.5 | 151 |
| Ru:Fe 50:50 | 4.8 | 5.1 | 157 |
| Ru:Fe 40:60 | 4.1 | 7.6 | 267 |
| Ru:Fe 30:70 | 4.3 | 6.5 | 298 |

The experimental results indicated that increasing ratios of iron were generally associated with higher yields and productivities.

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, and/or method described herein. In addition, any combination of two or more such features, systems, articles, materials, and/or methods, if such features, systems, articles, materials, and/or methods are not mutually inconsistent, is included within the scope of the present invention.

As used herein in the specification and in the claims, the phrase “at least a portion” means some or all. “At least a portion” may mean, in accordance with certain embodiments, at least 1 wt %, at least 2 wt %, at least 5 wt %, at least 10 wt %, at least 25 wt %, at least 50 wt %, at least 75 wt %, at least 90 wt %, at least 95 wt %, or at least 99 wt %, and/or, in certain embodiments, up to 100 wt %.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified unless clearly indicated to the contrary. Thus, as a non-limiting example, a reference to “A and/or B,” when used in conjunction with open-ended language such as “comprising” can refer, in one embodiment, to A without B (optionally including elements other than B); in another embodiment, to B without A (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

Unless clearly indicated to the contrary, concentrations and percentages described herein are on a mass basis.

As used herein, “wt %” is an abbreviation of weight percentage. As used herein, “at %” is an abbreviation of atomic percentage.

Some embodiments may be embodied as a method, of which various examples have been described. The acts performed as part of the methods may be ordered in any suitable way. Accordingly, embodiments may be constructed in which acts are performed in an order different than illustrated, which may include different (e.g., more or less) acts than those that are described, and/or that may involve performing some acts simultaneously, even though the acts are shown as being performed sequentially in the embodiments specifically described above.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

In the claims, as well as in the specification above, all transitional phrases such as “comprising,” “including,” “carrying,” “having,” “containing,” “involving,” “holding,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

1. A heterogeneous catalyst composition for gas-phase catalysis, the catalyst composition comprising:
an oxide support material comprising oxygen, 2-5 different metal elements, and optionally nitrogen and/or hydrogen; and
a metallic material associated with a surface of the oxide support material, wherein the metallic material has a formula of FeᵢRuⱼTₖ, wherein Fe is iron, Ru is ruthenium, and T is a transition metal other than Fe or Ru; and wherein 0<i<=100, 0<=j<100, 0<=k<50, and i+j+k=100.

2. The composition of claim 1, wherein the metallic material has a formula of FeᵢRuⱼTₖ, wherein Fe is iron, Ru is ruthenium, and T is a transition metal other than Fe or Ru; and wherein 1<i<99, 1<j<99, 0<=k<50, and i+j+k=100.

3. The composition of claim 1, wherein the oxide support material has a formula of AᵢDⱼEₖOₓN_{y}H_{z},
wherein A is a first of the 2-5 different metal elements, D is a second of the 2-5 different metal elements and is different from A, E is a third of the 2-5 different metal elements and is different from A and D, and O is oxygen, N is nitrogen, and H is hydrogen, wherein i, j, and k are 0<i<1, 0<j<1, and 0<=k<1 respectively, and i+j+k=1; and wherein x, y, and z are 0.5<x<2.5, 0<=y<1, and 0<=z<1 respectively.

4. The composition of claim 3, wherein A is a metal selected from Groups 2 or 3 of the periodic table specifically excluding lanthanoids, and D is a metal selected from Groups 5-11 of the periodic table.

5. The composition of claim 1, wherein the metallic material is comprised solely of Ru and Fe.

6. The composition of claim 3, wherein y and z are 0.

7-12. (canceled)

13. The composition of claim 1, wherein the composition is configured to catalyze gas-phase hydrogenation.

14-21. (canceled)

22. The composition of claim 1, wherein the metallic material has a formula of FeᵢRuⱼTₖ, wherein Fe is iron, Ru is ruthenium, and T is a transition metal other than Fe or Ru; and wherein 0<i<100, 0<j<100, 0<=k<50, and i+j+k=100.

23. (canceled)

24. The composition of claim 1, wherein the metallic material is comprised solely of Fe.

25. The composition of claim 1, wherein the catalyst composition enables single-pass yields of ammonia synthesized from hydrogen gas and nitrogen gas precursors at a 3:1 H₂:N₂ ratio in excess of 3% at 350° C., 75 bar total pressure, and 10000 h⁻¹ gas hourly space velocity (GHSV).

26. The composition of claim 1, wherein the catalyst composition enables single-pass yields of ammonia synthesized from hydrogen gas and nitrogen gas precursors at a 3:1 H₂:N₂ ratio in excess of 5% at 350° C., 75 bar total pressure, and 5000 h⁻¹ gas hourly space velocity (GHSV).

27. A supported heterogeneous catalyst composition for gas-phase catalysis, the supported catalyst composition comprising:
a metallic material associated with a surface of a catalyst support material, wherein the metallic material has a formula of FeᵢRuⱼTₖ, wherein Fe is iron, Ru is ruthenium, and T is a transition metal other than Fe or Ru, and wherein 0<i<=100, 0<=j<100, 0<=k<50, and i+j+k=100, and
wherein the supported catalyst composition enables single-pass yields of ammonia synthesized from hydrogen gas and nitrogen gas precursors at a 3:1 H₂:N₂ ratio in excess of 5% at 350° C., 75 bar total pressure, and 5000 h⁻¹ gas hourly space velocity (GHSV).

28-35. (canceled)

36. The composition of claim 1, wherein the metallic material is on the surface of the support material.

37. The composition of claim 1, wherein the metallic material has a particle size ranging from 0.1 to 100 nm.

38. The composition of claim 1, wherein the support material has a BET surface area of at least 5 m²/g.

39. The composition of claim 1, wherein the catalyst composition comprises from 0.1 to 40.0% by weight of the metallic material.

40-41. (canceled)

42. The composition of claim 1, further comprising an electronic promoter, wherein the electronic promoter is selected from the group consisting of Li, Na, K, Rb, Cs, Mg, Ca, Sr, Ba, Ce, oxides thereof, salts thereof, and combinations thereof.

43. The composition of claim 1, further comprising a structural promoter, wherein the structural promoter is selected from the group consisting of MgO, Al₂O₃, CaCO₃, zeolites, graphene oxide nanosheets, activated carbons, meso-porous carbons, meso-porous silicas, melon foams and combinations thereof.

44. (canceled)

45. The composition of claim 1, wherein the catalyst composition has an agglomerated particle size ranging from 25 μm to 10 mm as measured via mechanical sieving.

46-47. (canceled)

48. A method of producing ammonia, the method comprising:
contacting a catalyst composition with a precursor gas stream comprising nitrogen and hydrogen gases, the catalyst composition comprising:
an oxide support material comprising oxygen, 2-5 different metal elements, and optionally nitrogen and/or hydrogen; and
a metallic material associated with a surface of the oxide support material, wherein the metallic material has a formula of FeᵢRuⱼTₖ, wherein Fe is iron, Ru is ruthenium, and T is a transition metal other than Fe or Ru; and wherein 0<i<=100, 0<=j<100, 0<=k<50, and i+j+k=100; and
producing ammonia at a surface of the catalyst composition.

49-91. (canceled)
